(19) United States
(12) Patent Application Publication
(10) Pub. No.: US 2025/0369073 A1
(43) Pub. Date: Dec. 4, 2025

(54) METHODS AND COMPOSITIONS TO RECOVER RARE EARTH ELEMENTS FROM ORGANIC SOLUTIONS

(71) Applicant: West Virginia University Board of Governors on Behalf of West Virginia University, Morgantown, WV (US)

(72) Inventors: Harry O. Finklea, Morgantown, WV (US); Tommee Larochelle, Morgantown, WV (US); James Constant, Morgantown, WV (US); David K. Hoffman, Morgantown, WV (US)

(21) Appl. No.: 18/875,325

(22) PCT Filed: Jun. 16, 2023
(86) PCT No.: PCT/US2023/025623

§ 371 Date: Dec. 16, 2024

Related U.S. Application Data
(60) Provisional application No. 63/352,700, filed on Jun. 16, 2022.

(51) Int. Cl. C22B 59/00; C01F 17/247; C22B 3/22; C22B 3/32

(52) U.S. Cl. CPC C22B 59/00; C01F 17/247; C22B 3/22; C22B 3/322

(57) ABSTRACT

In one aspect, the disclosure relates to oxalic acid-based extraction methods for the preparation of a pregnant leach solution obtained from a loaded organic phase obtained from a solvent extraction system, i.e., a LOPSES, wherein the loaded organic phase comprises an organic solvent and at least one REE and/or CM, as well as pregnant leach solution products or compositions obtained by the disclosed methods. The disclosure further relates to methods for preparing a loaded organic phase using a solvent extraction system. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/352,700, filed on Jun. 16, 2022, which is incorporated herein by reference in its entirety.

### STATEMENT REGARDING FEDERALLY SPONSORED RESEARCH

This disclosure was made with U.S. Government support under grant number DE-FE0031834, awarded by the Department of Energy. The U.S. government has certain rights in the disclosure.

### BACKGROUND

Rare earth elements (REEs) are useful and necessary for the manufacture of batteries that power hybrid and electric vehicles, catalytic converters, computer memory, fluorescent lighting and lasers, smartphones and tablet computers, cameras including electronic components and lenses, e-readers, magnets, night-vision goggles, GPS and communications equipment, military applications including precision-guided weapons and vehicle armor, aircraft engines, personal protective equipment, and in other applications including defense applications. Some REEs can be used in air pollution control mechanisms, oil refineries, in medical diagnostic equipment such as, for example, X-ray and MRI machines, as phosphors, as catalysts, as components of ceramics and paints, and/or as polishing compounds. Although REEs and critical minerals (CM) can be extracted from many waste products and ores, few such resources are economically attractive. Due to current and possibly continuing export controls for REEs from China, it would be desirable to develop domestic sources of REEs.

Acid mine drainage (AMD) is a pollutant generated by coal and other mines and must be treated in compliance with federal and state clean water regulations to adjust pH and remove metal ions including iron, aluminum, and manganese. There are vast instances of acid mine drainage (AMD) in the northern, central, and southern Appalachian basins, as well as the Illinois coal basin and elsewhere in the U.S. Across the northern and central Appalachian Coal Basins, water pollution caused by AMD is the single greatest cause of stream impairment. Processes for treating AMD for regulatory compliance have been the subject of massive research and infrastructure investments since the early 1970s. It is estimated that, in the Appalachian states alone, more than 50 new, large AMD treatment plants will be installed in the next 10 years, in an effort to address increasing stream pollution. Although trace amounts of REEs are known to exist in AMD, a reliable method of concentrating and extracting them has only recently been described, e.g., see U.S. patent application Ser. Nos. 16/795,471, 17/115,128, and 17/706,584, as well as Intl. Pat. Appl. No. PCT/US2020/042674.

Despite advances in the treatment of acid mine drainage, and methods of concentrating and extracting rare earth elements and critical metals from same, there remains a need for further improvements of handling feedstreams produced from these sources, e.g., further processing of AMD-based pre-concentrate materials that has a low acid consumption, limited silica leaching, and further removes impurities while retaining the desired rare earth elements and critical metals. These needs and other needs are satisfied by the present disclosure.

### SUMMARY

In accordance with the purpose(s) of the disclosure, as embodied and broadly described herein, the disclosure, in one aspect, relates to oxalic acid-based extraction methods for the preparation of a pregnant leach solution obtained from a loaded organic phase obtained from a solvent extraction system, i.e., a LOPSES, wherein the loaded organic phase comprises an organic solvent and at least one REE and/or CM, as well as pregnant leach solution products or compositions obtained by the disclosed methods.

Disclosed are methods for preparation of a pregnant leach solution-post organic extraction, the method comprising: providing a loaded organic phase from a solvent extraction system (LOPSES) comprising an organic solvent and at least one REE; adding water and oxalic acid; mixing the water and the oxalic acid with the LOPSES, thereby forming a mixture comprising a partially stripped organic solvent and a slurry comprising a REE-oxalate precipitate and water; removing the partially stripped organic solvent from a slurry comprising the REE-oxalate precipitate and the water; and filtering the slurry in a filtration apparatus, thereby forming a retentate and a filtrate; wherein the organic solvent comprises at least one organic solvent; wherein the REE-oxalate precipitate comprises at least one REE; wherein the partially stripped organic solvent comprises at least one REE; wherein the retentate comprises a light REE-oxalate precipitate; and wherein the filtrate comprises water.

Also disclosed are methods for preparation of a pregnant leach solution-post organic extraction, the method comprising: providing a loaded organic phase from a solvent extraction system (LOPSES) comprising an organic solvent and at least one REE; adding an aqueous oxalate solution; mixing the aqueous oxalate solution with the LOPSES, thereby forming a mixture comprising a partially stripped organic solvent and a first slurry comprising a first REE-oxalate precipitate and water; removing the partially stripped organic solvent from a first slurry; adding water and oxalic acid to the removed partially stripped organic solvent thereby forming a twice-stripped organic solvent and a second slurry comprising a second REE-oxalate precipitate and water; removing the twice-stripped organic solvent from the second slurry; filtering the first slurry in a first filtration apparatus, thereby forming a first retentate and a first filtrate; and filtering the second slurry in a second filtration apparatus, thereby forming a second retentate and a second filtrate; wherein the organic solvent comprises at least one organic solvent; wherein the first REE-oxalate precipitate comprises at least one REE; wherein the second REE-oxalate precipitate comprises at least one REE; wherein the partially stripped organic solvent comprises at least one REE; wherein the first retentate comprises a light REE-oxalate precipitate; wherein the second retentate comprises a heavy REE-oxalate precipitate; wherein the first filtrate comprises water; and wherein the second filtrate comprises water.

Also disclosed are pregnant leach solution-post organic extraction products prepared by the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show aspects of a disclosed process for preparation of a pregnant leach solution from loaded organic phase, e.g., a loaded organic phase from a solvent extraction system (LOPSES) as disclosed herein in which the loaded organic phase comprises an organic solvent and at least one REE and/or CM. FIG. 1A shows a general process flow for the disclosed process for preparation of a pregnant leach solution from a LOPSES. FIG. 1B shows a general process flow for a further disclosed process for preparation of a pregnant leach solution from a LOPSES.

FIG. 2 shows representative data for mass percent (indicated in figure as “mass %”) of calcined solids (gangue metals and REEs as indicated) using a disclosed oxalic acid extraction method at three pHs as further discussed herein below. The oxalic acid solution pH was adjusted using sodium hydroxide.

FIGS. 3A-3B show representative data for mass percent of specific components extracted from a loaded organic phase using a disclosed oxalic acid extraction method as further discussed herein below. FIG. 3A shows mass % calcium extracted from a loaded organic phase into an oxalate stripping solution and subsequently in the hydrochloric acid stripping solution. FIG. 3B shows mass % zinc extracted from a loaded organic phase into an oxalate stripping solution and subsequently in the hydrochloric acid stripping solution. The oxalic acid solution pH was adjusted using sodium hydroxide.

FIG. 4 shows representative data for mass percent of the indicated REE in the calcined solid, using a disclosed oxalic acid extraction method as further discussed herein below, as a function of the pH of the oxalic acid solution. The oxalic acid solution pH was adjusted using sodium hydroxide.

FIGS. 5A-5C show representative data for percent of the indicated REE extracted from a loaded organic phase into the oxalate solution (darker gray as indicated in the figure) and then into the hydrochloric acid solution (lighter gray as indicated in the figure) as a function of the pH of the oxalic acid solution using a disclosed oxalic acid extraction method as further discussed herein below. FIG. 5A shows percent REE extracted from a loaded organic phase into the oxalate solution (darker gray as indicated in the figure) and then into the hydrochloric acid solution (lighter gray as indicated in the figure) as when using an oxalic acid solution having pH 1.6. FIG. 5B shows percent REE extracted from a loaded organic phase into the oxalate solution (darker gray as indicated in the figure) and then into the hydrochloric acid solution (lighter gray as indicated in the figure) as when using an oxalic acid solution having pH 3. FIG. 5C shows percent REE extracted from a loaded organic phase into the oxalate solution (darker gray as indicated in the figure) and then into the hydrochloric acid solution (lighter gray as indicated in the figure) as when using an oxalic acid solution having pH 4. In the foregoing, the pH of the oxalic acid solution was adjusted using sodium hydroxide as appropriate.

FIG. 6 shows representative data for mass percent (indicated in figure as “mass %”) of calcined solids (gangue metals and REEs as indicated) from a disclosed oxalic acid extraction method at three pHs as further discussed herein below. The oxalic acid solution pH was adjusted using ammonia.

FIGS. 7A-7B show representative data for mass percent of specific components extracted from a loaded organic phase using a disclosed oxalic acid extraction method as further discussed herein below. FIG. 7A shows mass % calcium extracted from a loaded organic phase into an oxalate stripping solution and subsequently in the hydrochloric acid stripping solution. FIG. 7B shows mass % zinc extracted from a loaded organic phase into an oxalate stripping solution and subsequently in the hydrochloric acid stripping solution. The oxalic acid solution pH was adjusted using ammonia.

FIG. 8 shows representative data for mass percent of the indicated REE in the calcined solid, using a disclosed oxalic acid extraction method as further discussed herein below, as a function of the pH of the oxalic acid solution. The oxalic acid solution pH was adjusted using ammonia.

FIGS. 9A-9C show representative data for percent of the indicated REE extracted from a loaded organic phase into the oxalate solution (lighter gray as indicated in the figure) and then into the hydrochloric acid solution (darker gray as indicated in the figure) as a function of the pH of the oxalic acid solution using a disclosed oxalic acid extraction method as further discussed herein below. FIG. 9A shows percent REE extracted from a loaded organic phase into the oxalate solution (lighter gray as indicated in the figure) and then into the hydrochloric acid solution (darker gray as indicated in the figure) as when using an oxalic acid solution having pH 1.6. FIG. 9B shows percent REE extracted from a loaded organic phase into the oxalate solution (lighter gray as indicated in the figure) and then into the hydrochloric acid solution (darker gray as indicated in the figure) as when using an oxalic acid solution having pH 3. FIG. 9C shows percent REE extracted from a loaded organic phase into the oxalate solution (lighter gray as indicated in the figure) and then into the hydrochloric acid solution (darker gray as indicated in the figure) as when using an oxalic acid solution having pH 4. In the foregoing, the pH of the oxalic acid solution was adjusted using ammonia as appropriate.

FIG. 10 shows a representative schematic overview of a process unit operation diagram of a disclosed process for preparation of a pregnant leach solution from loaded organic phase, e.g., a loaded organic phase from a solvent extraction system (LOPSES) as disclosed herein in which the loaded organic phase comprises an organic solvent and at least one REE and/or CM, such as depicted in FIG. 1A.

FIG. 11 shows a representative schematic overview of a process unit operation diagram of a disclosed process for preparation of a pregnant leach solution from loaded organic phase, e.g., a loaded organic phase from a solvent extraction system (LOPSES) as disclosed herein in which the loaded organic phase comprises an organic solvent and at least one REE and/or CM, such as depicted in FIG. 1B.

FIG. 12 shows a representative schematic overview of a process unit operation diagram of a metathesis processing unit used in a disclosed process for preparation of a pregnant leach solution from loaded organic phase, e.g., a loaded organic phase from a solvent extraction system (LOPSES) as disclosed herein in which the loaded organic phase comprises an organic solvent and at least one REE and/or CM, such as depicted in FIG. 11.

FIGS. 13A-13D show representative schematic overviews of a process flow diagram of a disclosed process for batch solvent extraction of an input, e.g., a PLS material or composition, comprising a multi-port design and as depicted and further described in FIG. 14, and schematic representations of various aspects of the batch solvent extraction unit. FIG. 13A shows a process flow diagram using a multi-port design is useful for the extraction of a pregnant leach solution to prepare a disclosed loaded organic phase, i.e., preparation of a loaded organic phase from a solvent extraction system (LOPSES) as disclosed herein in which the loaded organic phase comprises an organic solvent and at least one REE and/or CM. That is, the depicted process unit operation is a representative disclosed process for preparation of a disclosed LOPSES process. FIG. 13B shows a representative three-dimensional rendering of an exemplary batch solvent extraction unit utilizing a three-port design, specifically the tank and various components associated with the tank. FIG. 13C shows a representative batch solvent extraction unit for a disclosed batch solvent extraction process utilizing a three-port design. FIG. 13C shows a representative batch solvent extraction flow schematic for a disclosed batch solvent extraction process. FIG. 13D shows an exemplary batch solvent extraction unit process flow schematic utilizing a three-port design with expanded network connection to other processing units and systems as disclosed herein.

FIG. 14 shows aspects of a disclosed process for batch solvent extraction of a pregnant leach solution used for the preparation of a disclosed loaded organic phase, i.e., preparation of a loaded organic phase from a solvent extraction system (LOPSES) as disclosed herein in which the loaded organic phase comprises an organic solvent and at least one REE and/or CM that is depicted in the schematic overviews of a process flow diagram of a disclosed process for batch solvent extraction of an input, e.g., a PLS material or composition, comprising a two-port design and as depicted, and schematic representations of various aspects of the exemplary batch solvent extraction unit, in FIGS. 13A-13D. That is, the depicted batch solvent extraction is a representative disclosed process for preparation of a LOPSES.

FIG. 15 shows a representative schematic overview of a process unit operation diagram of a disclosed process for batch solvent extraction of an input, e.g., a PLS material or composition, comprising a three-port design and as depicted and further described in FIG. 16. The process unit operation is useful for extraction of a pregnant leach solution to prepare a disclosed loaded organic phase, i.e., preparation of a loaded organic phase from a solvent extraction system (LOPSES) as disclosed herein in which the loaded organic phase comprises an organic solvent and at least one REE and/or CM. That is, the depicted batch solvent extraction carried using the process unit operation depicted is a representative disclosed process for preparation of a LOPSES.

FIG. 16 shows aspects of a disclosed process for batch solvent extraction of a pregnant leach solution used for the preparation of a disclosed loaded organic phase, i.e., preparation of a loaded organic phase from a solvent extraction system (LOPSES) as disclosed herein in which the loaded organic phase comprises an organic solvent and at least one REE and/or CM that is depicted in the process unit diagram in FIG. 15. That is, the depicted batch solvent extraction is a representative disclosed process for preparation of a LOPSES.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element” includes, but is not limited to, mixtures of two or more such rare earth elements, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a buffer refers to an amount that is sufficient to achieve the desired improvement in the property modulated by the formulation component, e.g., achieving and maintaining a desired solution pH. The specific level in terms of wt % in a composition required as an effective amount will depend upon a variety of factors including the amount and type of buffer, size of processing plant (i.e., bench top, mobile, or commercial scale), amount and type of feedstock being treated, and end use of the REEs recovered during the process.

As used herein, the terms “optional” or “optionally” means that the subsequently described event or circumstance can or cannot occur, and that the description includes instances where said event or circumstance occurs and instances where it does not.

As used herein, the term “rare earth element” (REE), in the context of the present disclosure, refers to a composition comprising one or more rare earth elements, including one or more of a lanthanide chemical element, i.e., cerium, dysprosium, erbium, europium, gadolinium, holmium, lanthanum, lutetium, neodymium, praseodymium, samarium, scandium, terbium, thulium, ytterbium, and yttrium. The elements scandium and yttrium often occur in the same ore deposits as lanthanides and also have some similar chemical properties. Rare earth elements are useful in a variety of applications in the electronics, defense, and medical industries, as well as in other applications. An oxide of a rare earth element is a “rare earth oxide” and can be used for analytical purposes or may be useful as a component of ceramics, catalysts, and/or coatings, among other uses. It is to be understood that when referencing rare earth elements that any of the elements can be present in a zero valence or elemental state, or in an ionized or valence state associated in the art with the individual element, and all forms are understood to be collectively included within the meaning of “rare earth elements”. Moreover, it is to be understood that reference to any individual rare earth element, i.e., any one of lanthanum, cerium, praseodymium, neodymium, samarium, europium, gadolinium, terbium, dysprosium, holmium, erbium, thulium, ytterbium, lutetium, including scandium and yttrium, can be present in a zero valence or elemental state, or in an ionized or valence state associated in the art with the given element, and all forms are understood to be collectively included within the meaning of reference to said element. For example, reference to “lanthanum”, “an element such as lanthanum”, “a composition comprising lanthanum”, and the like, it is understood that the reference inclusive any or all forms of lanthanum such as La⁰, La⁺¹, La⁺², and La⁺³. It is further understood that a reference to any given rare earth element is inclusive of all isotopic forms of the element.

As used herein, the terms “heavy rare earth element” and “HREE”, in the context of the present disclosure, can be used interchangeably and refer to one or more element selected from dysprosium, erbium, holmium, lutetium, thulium, ytterbium, and yttrium. It is to be understood that yttrium can be classified as a heavy rare earth element due to chemical properties and co-location with other HREEs in ores but can also be yttrium is classified as a light rare earth element due to its lower atomic weight. However, in the context of segregation of REEs into only HREE and LREE (without separation of MREE), HREE refers to one or more element selected from dysprosium, erbium, holmium, lutetium, terbium, thulium, ytterbium, and yttrium.

As used herein, the terms “middle rare earth element” and “MREE”, in the context of the present disclosure, can be used interchangeably and refer to one or more element selected from europium, gadolinium, samarium, and terbium. In some aspects, these designations may differ slightly but are generally based on atomic weight.

As used herein, the terms “light rare earth element” and “LREE”, in the context of the present disclosure, can be used interchangeably and refer to one or more element selected from cerium, lanthanum, neodymium, and praseodymium. In some aspects, these designations may differ slightly but are generally based on atomic weight. However, in the context of segregation of REEs into only HREE and LREE (without separation of MREE), LREE refers to one or more element selected from cerium, europium, gadolinium, lanthanum, neodymium, praseodymium, samarium, and scandium.

As used herein, the term “total rare earth element” and “TREE”, in the context of the present disclosure, can be used interchangeably and refer to the total REE present in a disclosed composition or product of a disclosed process, method, or device, wherein the TREE comprises one or more of REE selected from lanthanum, cerium, praseodymium, neodymium, samarium, europium, gadolinium, terbium, dysprosium, holmium, erbium, thulium, ytterbium, lutetium, scandium and yttrium.

“Critical minerals” (CM) as used herein include minerals important to national security and the economy which are distinct from REEs. Like REEs, CMs are considered critical minerals due to their numerous industrial uses. As used in the context of the present disclosure, certain CMs may also be purified and concentrated using the disclosed process and include one or more of the non-rare earth elements selected from cobalt, gallium, germanium, hafnium, indium, lithium, magnesium, manganese, nickel, niobium, rhenium, rubidium, tantalum, tellurium, and zinc. However, the foregoing is merely exemplary and depending upon source from which the PLS is obtained, additional or alternative CMs may be obtained. It should be noted that the U.S. Geological Survey regularly makes a determination of minerals critical to the U.S. economy, with the last list having been made publicly available on or about Feb. 22, 2022 (e.g., see Federal Register, Vol. 87, No. 37, Thursday, Feb. 24, 2022, p. 10381-10382 and https://www.usgs.gov/news/national-news-release/us-geological-survey-releases-2022-list-critical-minerals, last accessed Jun. 16, 2023; each of which is incorporated by reference). As used in the context of the present disclosure, a CM may further include one or more mineral identified in the U.S. Geological Survey that is not a REE as defined herein.

As used herein, “gangue” metals and other materials are undesired materials that surround or are co-located with the REEs being isolated and concentrated by the disclosed process. In one aspect, in the present process, gangue material can include, but is not limited to, aluminum, calcium, magnesium, manganese, silicon, chloride, and the like. In some aspects, gangue materials may have little or no economic value. In other aspects, gangue materials may have industrial uses but their presence alongside more valuable REEs can complicate the recovery of the REEs.

As used herein, “total major metals” and “TMM”, which can be used interchangeably, refer to one or more metals that can include gangue metals and CMs present in various compositions and materials, e.g., PLS, AMD, and the like, and can include one or more metal selected from the above listed gangue metals and CMs. In a particular instance, TMMs refer to one or more metal selected from aluminum, calcium, cobalt, iron, magnesium, manganese, sodium, nickel, silicon, and zinc.

“Acid mine drainage” (AMD) as used herein refers to acidic water that outflows from mines such as, for example, metal mines or coal mines. In one aspect, AMD intensifies in scale and scope when construction, mining, and other activities that disturb the earth occur in and around rocks containing sulfide minerals. AMD can have high concentrations of metal ions that can cause detrimental effects to aquatic environments, especially in combination with low pH. AMD from coal mines and other sources often contains trace amounts of REEs, as well. “Acid mine drainage” as understood within the definition herein can be aqueous effluent from mining operations, mill tailings, overburden from mining operations, excavations, acid process waste streams, seepages, and other aqueous flows having elevated levels of metal ions and/or anions. Acid mine drainage is characterized by the presence of metals such as iron, manganese, aluminum, cadmium, cobalt, copper, lead, magnesium, molybdenum, nickel, zinc, and others. Acid mine drainage may also include undesirable anions such as sulfate, fluoride, nitrate and chloride. As used in the present application, “mine” is understood to mean active, inactive or abandoned mining operations for removing minerals, metals, ores or coal from the earth. Environmental regulations promulgated by the Environmental Protection Agency under CAA, RCRA, and CERCLA, as well as those promulgated by state and local authorities, mandate that the concentration of certain minerals and metals in specific aqueous effluents be less then the established regulatory levels.

“AMD precipitate” (AMDp) as used herein refers to a byproduct of AMD treatment. In one aspect, AMDp contains REEs but may also contain gangue metals such as, for example, iron and aluminum. In one aspect, AMDp contains from about 0.06% to about 0.1% REE. As used herein, “enriched AMD precipitate” (eAMDp) refers to an AMD product having from about 0.1% to about 5% REE on a dry weight basis. In another aspect, eAMDp has a lower gangue metal content then AMDp.

A “feedstock” as used herein is a raw material processed to recover REEs and other valuable components (e.g., CMs). A feedstock may be too toxic to release into the natural environment and, in one aspect, the disclosed process can remove commercially valuable components from the feedstock while simultaneously rendering the feedstock suitable for environmental release.

As used herein, “pregnant leach solution” and “REE/CM pregnant leach solution”, which can be used interchangeably and are represented by the acronym (PLS), refer to an aqueous solution with an acidic pH and a high REE/CM content. In one aspect, PLS can be processed using several purification technologies including, but not limited to, solvent extraction, ion exchange resins, selective precipitation, and fractional crystallization to remove and/or concentrate the metals. The PLS can have a high solids content and may require filtration prior to further processing.

As used herein, “loaded organic phase from a solvent extraction system” and “REE/CM loaded organic phase from a solvent extraction system” which can be used interchangeably and are represented by the acronym “LOPSES”, refer to organic solution or mixture prepared by solvent extraction of a suitable PLS, e.g., a PLS prepared from a REE/CM pre-concentrate, and enriched in one or more REE and other metals as described herein below. The LOPSES can comprise one or more organic solvents and is enriched in one or more REE/CM. In some instances, there can be some water or an aqueous solution present in the LOPSES.

As used herein, “pregnant leach solution-LOPSES” and “REE/CM pregnant leach solution-LOPSES”, which can be used interchangeably and are represented by the acronym “PLS-LOPSES”, refer to a pregnant leach solution enriched in one or more REE/CM and prepared using the disclosed methods, e.g., the disclosed one-step oxalate precipitation method or disclosed two-step oxalate precipitation method, to recover REE/CMs from a LOPSES. The PLS-LOPSES is an aqueous solution comprising a high REE/CM.

“Raffinate,” meanwhile, refers to a product of chemical separation, wherein one or more components have been removed. In one aspect, following solvent extraction as disclosed herein, raffinate is the aqueous component depleted in REE content. In another aspect, raffinate can include undesired gangue material.

As used herein, “GEOTUBER” refers to a dewatering device made from a polypropylene fabric that can be produced according to the needs of a particular project or industry. In one aspect, sludge or other material to be separated is pumped into a GEOTUBE® container and a fabric liner keeps solids trapped inside while filtrate water escapes and can be directed to a treatment facility.

As used herein, “contacting” refers to the act of touching, making contact, or of bringing substances into immediate proximity.

As used herein, “decanting” or “decantation” includes pouring off a fluid, leaving a sediment or precipitate, thereby separating the fluid from the sediment or precipitate. The sediment or precipitate can be present as a slag.

As used herein, “filtering” or “filtration” refers to a mechanical method to separate solids from liquids by passing the feed stream through a porous sheet such as a paper, ceramic or metal membrane, which retains the solids and allows the liquid to pass through. This can be accomplished by gravity, pressure or vacuum (suction). The filtering effectively separates the sediment and/or precipitate from the liquid.

As used herein, “clarifier” refers to a device used to separate suspended solids, precipitates, and colloidal particles from a fluid stream including, but not limited to, a sedimentation tank, wier tank, dissolved air flotation, and filtration.

As used herein, “clarification” refers to a process used to separate suspended solids, precipitates, and colloidal particles from a fluid stream using a device such as, but not limited to, a sedimentation tank, wier tank, dissolved air flotation, and filtration.

Unless otherwise specified, temperatures referred to herein are based on atmospheric pressure (i.e., one atmosphere).

### Acronyms.

The following acronyms as follows are used herein throughout. It is understood that the fully written phrase or textual description can be used interchangeably with the acronym without changing the intended meaning.

| ACRONYM/ | |
|---|---|
| ABBREVIATION | BRIEF DESCRIPTION |
| AL | Acid Leaching |
| ALSX | Acid Leaching/Solvent Extraction |
| AMD | Raw Acid Mine Drainage |
| AMDp | Precipitate formed from AMD |
| BSX | Batch Solvent Extraction |
| CM | Critical Minerals |
| HPC | Hydraulic Pre-Concentrate |
| HREE | Heavy Rare Earth Element |
| HREO | Heavy Rare Earth Oxide |
| ICP-MS | Inductively Coupled Plasma Mass Spectrometry |
| ICP-OES | Inductively Coupled Plasma Optical Emission |
| | Spectrometry |
| LO | Loaded Organic (e.g., as used in connection |
| | with LO Storage) |
| LREE | Light Rare Earth Elements |
| LREO | Light Rare Earth Oxide |
| LOPSES | Loaded Organic Phase from a Solvent Extraction |
| | System |
| MixedREE | Mixed Rare Earth Elements |
| MREE | Middle Earth Elements |
| MREO | Mixed Rare Earth Oxide |
| M-S | Mixer-Settler (e.g., as used in connection |
| | with M-S Tank) |
| NPDES | National Pollution Discharge Elimination System |
| OA | Oxalic Acid |
| O:A | Organic:Aqueous ratio (e.g., as used in |
| | connection with O:A Ratio) |
| PC | Pre-Concentrate |
| PLS | Pregnant Leach Solution |
| PLS-LOPSES | Pregnant Leach Solution prepared from LOPSES |
| PVDF | Polyvinylidene fluoride |
| RAFF | Raffinate material |
| RE or REE | Rare Earth or Rare Earth Element |
| REE/CM | Rare Earth Element/Critical Mineral |
| REEF | Rare Earth Extraction Facility |
| RO | Recycled Organic (e.g., as used in |
| | connection with RO Storage) |
| SX | Solvent Extraction |
| TMM | Total Major Metals |
| WVU | West Virginia University |
| WVDEP | West Virginia Department of Environmental |
| | Protection |

### B. AMD and Preparation of REE/CM Pre-Concentrate

REE/CMs are typically obtained from ore deposits. However, there are several issues associated with reliance on ore deposits as source material for REE/CMs, including, but not limited to, national security concerns around sourcing from essentially one country and the large volumes of potentially toxic waste associated with production of REE/CMs from mineral ores. There is an attractive alternative to mineral ores as a primary source for REE/CMs, namely acid mine drainage from operating and closed mines such as coal mines and hard rock mining operations. Acid mine drainage is a byproduct of the foregoing mining operations that is enriched in many REE/CMs, and as such, offers an opportunity for their preparation from readily available materials.

In various aspects, an AMD can be treated prior to discharge into the environment, e.g., mixing the AMD with lime to precipitate metals and to raise the pH. After settling and filtration, the treated water can normally be discharged to the environment. Generally, the conventional methods of treating AMD prior to discharge can be modified to provide a useful pre-concentrate that can serve as a feedstock for the disclosed methods of preparing a pregnant leach solution. For example, in a first step, the AMD can be titrated with lime (calcium oxide) to pH 4.0-4.5 to precipitate aluminum and iron. Following removal by settling or filtration of the precipitated materials, the clarified water can then be titrated to pH 8.5 with lime. At this pH, the REE/CMs precipitate as hydroxides along with other metals. The precipitate can be collected by use of settling systems or filtration, then dried or partially dried to form the pre-concentrate. The pre-concentrate thus obtained can be shipped for further processing and recovery of REE/CMs.

Various methods for preparation of REE/CM pre-concentrate materials from AMD have recently been described, including those disclosed in U.S. patents application Ser. Nos. 16/795,471, 17/115,128, and 17/706,584, as well as Intl. Pat. Appl. No. PCT/US2020/042674, each of which is incorporated herein by reference, particularly with reference to the methods of preparing REE/CM pre-concentrate materials from AMD (collectively referred to herein as “WVU REE/CM pre-concentrate processes”). The foregoing methods provide facile and high yield methods for increasing the concentration of REE/CMs compared to the original source AMD, removing gangue and other undesirable minerals or materials from the AMD, and providing a final product, a REE/CM pre-concentrate material, that is a useful feedstock for further enrichment and purification of REE/CMs. Other methods of preparing a suitable REE/CM pre-concentrate material comprising one or more REE/CM prepared from a suitable feedstock, e.g., an AMD material, may be known to the skilled artisan and can be utilized as a feedstock in the methods described herein below for the preparation of a PLS.

In a further aspect, a pre-concentrate used in the disclosed methods for preparation of a pregnant leach solution is a pre-concentrate obtained from one or more of the WVU REE/CM pre-concentrate processes. In a still further aspect, the pre-concentrate obtained from the one or more of the WU REE/CM pre-concentrate processes is a pre-concentrate solution such as a slurry pre-concentrate, hydraulic pre-concentrate, liquid pre-concentrate, or other semi-solid pre-concentrate mixture comprising liquid and REE/CMs suspended or dissolved in the liquid phase.

In a further aspect, a pre-concentrate used in the disclosed methods for preparation of a pregnant leach solution is a pre-concentrate obtained from one or more processes known to the skilled artisan. In a still further aspect, the pre-concentrate obtained from one or more of the one or more processes known to the skilled artisan is a pre-concentrate solution such as a slurry pre-concentrate, hydraulic pre-concentrate, liquid pre-concentrate, or other semi-solid pre-concentrate mixture comprising liquid and REE/CMs suspended or dissolved in the liquid phase.

In a further aspect, a pre-concentrate—prepared by any of the foregoing referenced processes—that is a pre-concentrate solution such as a slurry pre-concentrate, hydraulic pre-concentrate, liquid pre-concentrate, or other semi-solid pre-concentrate mixture comprising liquid and REE/CMs suspended or dissolved in the liquid phase can be further treated to obtain a dried or essentially dry pre-concentrate. For example, a slurry, hydraulic pre-concentrate, liquid concentrate, or other mixture comprising liquid and REE/CMs suspended or dissolved in the liquid phase can be heated, dried by passive evaporation (e.g., in evaporative ponds or tanks), or a significant proportion of liquid removed using geobags. In drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is about 50%, about 55%, about 60%, about 65%, about 70%, about 75%, about 80%, about 85%, about 90%, about 95%, about 97%, about 98%, about 99%, about 100%; or a range encompassing as a lower and upper end any two of the foregoing value; or any combination of discrete values from the foregoing values. In a still further aspect, drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is from about 90% to about 100%. In a yet further aspect, drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is from about 95% to about 100%. In an even further aspect, drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is from about 98% to about 100%.

In various aspects, a pre-concentrate that is a slurry pre-concentrate, hydraulic pre-concentrate, liquid pre-concentrate, or other semi-solid pre-concentrate mixture has a solids concentration of from about 0.05% solids to about 5% solids; from about 0.1% solids to about 4.5% solids; from about 0.1% solids to about 4.0% solids; from about 0.1% solids to about 3.5% solids; from about 0.1% solids to about 3.0% solids; from about 0.1% solids to about 2.5% solids; from about 0.1% solids to about 2.0% solids; from about 0.1% solids to about 1.5% solids; from about 0.1% solids to about 1.0% solids; from about 0.1% solids to about 0.7% solids; or from about 0.1% solids to about 0.5% solids.

In a further aspect, a pre-concentrate that is a slurry pre-concentrate, hydraulic pre-concentrate, liquid pre-concentrate, or other semi-solid pre-concentrate mixture has a solids concentration of from about 0.1% solids to about 10% solids; from about 0.2% solids to about 9% solids; from about 0.2% solids to about 9% solids; from about 0.2% solids to about 7.5% solids; from about 0.2% solids to about 6% solids; from about 0.2% solids to about 5% solids; from about 0.2% solids to about 4% solids; from about 0.2% solids to about 3% solids; from about 0.2% solids to about 2% solids; from about 0.2% solids to about 1.5% solids; or from about 0.2% solids to about 1% solids.

In a further aspect, a pre-concentrate that is a slurry pre-concentrate, hydraulic pre-concentrate, liquid pre-concentrate, or other semi-solid pre-concentrate mixture has a solids concentration of from about 1% solids to about 10% solids; from about 1% solids to about 9% solids; from about 1% solids to about 9% solids; from about 1% solids to about 7.5% solids; from about 1% solids to about 6% solids; from about 1% solids to about 5% solids; from about 1% solids to about 4% solids; from about 1% solids to about 3% solids; from about 1% solids to about 2% solids; or from about 1% solids to about 1.5% solids.

In a further aspect, a pre-concentrate that is a slurry pre-concentrate, hydraulic pre-concentrate, liquid pre-concentrate, or other semi-solid pre-concentrate mixture has a solids concentration of from about 2% solids to about 10% solids; from about 2% solids to about 9% solids; from about 2% solids to about 9% solids; from about 2% solids to about 7.5% solids; from about 2% solids to about 6% solids; from about 2% solids to about 5% solids; from about 2% solids to about 4% solids; or from about 2% solids to about 3% solids.

In a further aspect, a pre-concentrate that is a slurry pre-concentrate, hydraulic pre-concentrate, liquid pre-concentrate, or other semi-solid pre-concentrate mixture has a solids concentration of from about 3% solids to about 10% solids; from about 3% solids to about 9% solids; from about 3% solids to about 9% solids; from about 3% solids to about 7.5% solids; from about 3% solids to about 6% solids; from about 3% solids to about 5% solids; or from about 3% solids to about 4% solids.

In a further aspect, a pre-concentrate that is a slurry pre-concentrate, hydraulic pre-concentrate, liquid pre-concentrate, or other semi-solid pre-concentrate mixture has a solids concentration of from about 4% solids to about 10% solids; from about 4% solids to about 9% solids; from about 4% solids to about 9% solids; from about 4% solids to about 7.5% solids; from about 4% solids to about 6% solids; or from about 4% solids to about 5% solids.

In various aspects, a pre-concentrate that is a slurry pre-concentrate, hydraulic pre-concentrate, liquid pre-concentrate, or other semi-solid pre-concentrate mixture comprises lanthanum, cerium, praseodymium, neodymium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 5 mg/L to about 500 mg/L.

In a further aspect, a pre-concentrate that is a slurry pre-concentrate, hydraulic pre-concentrate, liquid pre-concentrate, or other semi-solid pre-concentrate mixture comprises lanthanum, cerium, praseodymium, neodymium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 50 mg/L to about 500 mg/L.

In a further aspect, a pre-concentrate that is a slurry pre-concentrate, hydraulic pre-concentrate, liquid pre-concentrate, or other semi-solid pre-concentrate mixture comprises lanthanum, cerium, praseodymium, neodymium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 100 mg/L to about 500 mg/L.

In various aspects, a pre-concentrate that is a slurry pre-concentrate, hydraulic pre-concentrate, liquid pre-concentrate, or other semi-solid pre-concentrate mixture comprises scandium at a concentration of from about 0.01 mg/L to about 0.5 mg/L; yttrium at a concentration of from about 1.0 mg/L to about 200 mg/L; lanthanum at a concentration of from about 0.01 mg/L to about 5 mg/L; cerium at a concentration of from about 0.5 mg/L to about 70 mg/L; praseodymium at a concentration of from about 0.1 mg/L to about 15 mg/L; neodymium at a concentration of from about 0.5 mg/L to about 80 mg/L; samarium at a concentration of from about 0.2 mg/L to about 30 mg/L; europium at a concentration of from about 0.05 mg/L to about 10 mg/L; gadolinium at a concentration of from about 0.2 mg/L to about 50 mg/L; terbium at a concentration of from about 0.05 mg/L to about 10 mg/L; dysprosium at a concentration of from about 0.2 mg/L to about 50 mg/L; holmium at a concentration of from about 0.05 mg/L to about 10 mg/L; erbium at a concentration of from about 0.1 mg/L to about 30 mg/L; thullium at a concentration of from about 0.01 mg/L to about 3 mg/L; ytterbium at a concentration of from about 0.05 mg/L to about 10 mg/L; and lutetium at a concentration of from about 0.01 mg/L to about 1 mg/L.

In various aspects, a pre-concentrate that is a slurry pre-concentrate, hydraulic pre-concentrate, liquid pre-concentrate, or other semi-solid pre-concentrate mixture comprises scandium at a concentration of from about 0.05 mg/L to about 0.15 mg/L; yttrium at a concentration of from about 20 mg/L to about 45 mg/L; lanthanum at a concentration of from about 0.3 mg/L to about 0.75 mg/L; cerium at a concentration of from about 5 mg/L to about 15 mg/L; praseodymium at a concentration of from about 1 mg/L to about 3.5 mg/L; neodymium at a concentration of from about 5 mg/L to about 20 mg/L; samarium at a concentration of from about 2 mg/L to about 7 mg/L; europium at a concentration of from about 0.5 mg/L to about 2 mg/L; gadolinium at a concentration of from about 5 mg/L to about 15 mg/L; terbium at a concentration of from about 0.5 mg/L to about 2 mg/L; dysprosium at a concentration of from about 4 mg/L to about 15 mg/L; holmium at a concentration of from about 0.5 mg/L to about 3 mg/L; erbium at a concentration of from about 2.5 mg/L to about 6 mg/L; thullium at a concentration of from about 0.2 mg/L to about 0.7 mg/L; ytterbium at a concentration of from about 0.7 mg/L to about 2.5 mg/L; and lutetium at a concentration of from about 0.05 mg/L to about 0.3 mg/L.

In various aspects, a preconcentrate used in the disclosed methods is a solid pre-concentrate material preparation comprising a pre-concentrate. The solid pre-concentrate material preparation can be a powder, an amorphous solid, a particulate, a block, or other solid form that is dry or substantially dry. If a solid pre-concentrate material preparation is used as a feedstock for a solvent extraction process for recovery of REE/CMs, the pre-concentrate can be dissolved in a mineral acid solution. The resulting solution contains high concentrations of silicate. Table 1 shows representative concentrations obtained when 1 gram of solid pre-concentrate material preparation obtained as described above is extracted with 20 milliliters of 1 molar solutions of hydrochloric acid, nitric acid and sulfuric acid. While the acids dissolved 80-90% of the REEs present in the pre-concentrate, they also dissolved a large portion of the silicates. Silicate concentrations of 2,000 to 4,000 milligrams per liter can cause problems in the solvent extraction system or other desired processing steps. For example, the presence of silicates-particularly at or about the foregoing concentrations—can promote crud formation which can foul the solvent extraction units and reduce the efficiency of separating REEs from the other metals present.

TABLE 1
Concentrations of silicon and total rare earths (TREE)
in mg/L after acid extraction of a pre-concentrate.

| | Acid Treatment | | |
|---|---|---|---|
| Species | HCl | HNO₃ | H₂SO₄ |
| Silicates | 2040 | 2860 | 3960 |
| TREE | 577 | 526 | 531 |

In various aspects, a solid pre-concentrate material preparation comprises a TREE concentration that is about 1000 mg TREE to about 50000 mg TREE per kg of solid pre-concentrate material. In a further aspect, a solid pre-concentrate material preparation comprises a TREE concentration that is about 2500 mg TREE to about 50000 mg TREE per kg of solid pre-concentrate material. In a still further aspect, a solid pre-concentrate material preparation comprises a TREE concentration that is about 3000 mg TREE to about 50000 mg TREE per kg of solid pre-concentrate material. In a yet further aspect, a solid pre-concentrate material preparation comprises a TREE concentration that is about 4000 mg TREE to about 50000 mg TREE per kg of solid pre-concentrate material. In an even further aspect, a solid pre-concentrate material preparation comprises a TREE concentration that is about 5000 mg TREE to about 50000 mg TREE per kg of solid pre-concentrate material. In a still further aspect, a solid pre-concentrate material preparation comprises a TREE concentration that is about 7500 mg TREE to about 50000 mg TREE per kg of solid pre-concentrate material. In a yet further aspect, a solid pre-concentrate material preparation comprises a TREE concentration that is about 10000 mg TREE to about 50000 mg TREE per kg of solid pre-concentrate material. In an even further aspect, a solid pre-concentrate material preparation comprises a TREE concentration that is about 20000 mg TREE to about 50000 mg TREE per kg of solid pre-concentrate material.

In various aspects, a solid pre-concentrate material preparation comprises a TREE concentration that is about 1000 mg TREE to about 40000 mg TREE per kg of solid pre-concentrate material. In a further aspect, a solid pre-concentrate material preparation comprises a TREE concentration that is about 1000 mg TREE to about 35000 mg TREE per kg of solid pre-concentrate material. In a yet further aspect, a solid pre-concentrate material preparation comprises a TREE concentration that is about 1000 mg TREE to about 30000 mg TREE per kg of solid pre-concentrate material. In an even further aspect, a solid pre-concentrate material preparation comprises a TREE concentration that is about 1000 mg TREE to about 25000 mg TREE per kg of solid pre-concentrate material. In a still further aspect, a solid pre-concentrate material preparation comprises a TREE concentration that is about 1000 mg TREE to about 20000 mg TREE per kg of solid pre-concentrate material. In a yet further aspect, a solid pre-concentrate material preparation comprises a TREE concentration that is about 1000 mg TREE to about 15000 mg TREE per kg of solid pre-concentrate material. In an even further aspect, a solid pre-concentrate material preparation comprises a TREE concentration that is about 1000 mg TREE to about 10000 mg TREE per kg of solid pre-concentrate material.

### C. Preparation of Pregnant Leach Solution from REE/CM Pre-Concentrate

A pregnant leach solution can be prepared from an AMD REE/CM pre-concentrate.

In various aspects, a pregnant leach solution useful for solvent extraction can be prepared by various methods for preparation of pregnant leach solutions from REE/CM pre-concentrate materials from AMD have recently been described, including those disclosed in U.S. patent application Ser. Nos. 16/795,471, 17/115,128, and 17/706,584, as well as Intl. Pat. Appl. No. PCT/US2020/042674 and U.S. Prov. Pat. Appl. No. 63/339,881, filed May 9, 2022, each of which is incorporated herein by reference, particularly with reference to the methods of preparing a pregnant leach solution from REE/CM pre-concentrate materials from AMD (collectively referred to herein as “WVU REE/CM pregnant leach processes”). The foregoing methods provide facile and high yield methods for the preparation of suitable pregnant leach solutions from REE/CM pre-concentrate materials such comprise the concentrated REE/CMs (compared to the original source AMD, diminished gangue and other undesirable minerals or materials from the AMD, and providing the REE/CM pre-concentrate material, that is a useful feedstock for further enrichment and purification of REE/CMs such as solvent extraction methods. Other methods of preparing a suitable PLS comprising one or more REE/CM prepared from a suitable feedstock, e.g., a REE/CM pre-concentrate material, may be known to the skilled artisan and can be utilized as a feedstock in the methods described herein below for the preparation of an LOPSES.

In various aspects, the pregnant leach solution obtained by the referenced methods for preparation of a pregnant leach solution comprises lanthanum, cerium, praseodymium, neodymium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 5 mg/L to about 500 mg/L.

In a further aspect, the pregnant leach solution obtained by the referenced methods for preparation of a pregnant leach solution comprises lanthanum, cerium, praseodymium, neodymium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 50 mg/L to about 500 mg/L.

In a further aspect, the pregnant leach solution obtained by the referenced methods for preparation of a pregnant leach solution comprises lanthanum, cerium, praseodymium, neodymium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 100 mg/L to about 500 mg/L.

### D. Preparation of REE/CM Loaded Solvent Extraction Organic Phase

A LOPSES can be prepared from a pregnant leach solution using solvent extraction methods which can selectively concentrate rare earth elements (REEs) and other critical materials from sources containing a mixture of other elements, i.e., an aqueous source solution is mixed with an organic phase containing ligands which are selective for REEs. In various aspects, solvent extraction can be used to selectively concentrate REEs and other critical materials from sources containing a mixture of other elements, e.g., to prepare a LOPSES as disclosed herein from a pregnant leach solution prepared from a REE/CM pre-concentrate as described herein, including, but not limited to REE/CM pre-concentrate prepared from various sources of AMD. In general, an aqueous source solution, e.g., a pregnant leach solution prepared from a REE/CM pre-concentrate, is mixed with an organic phase containing ligands which are selective for REEs. The organic phase is a mixture of hydrocarbons, such as a mixture comprising at least one hydrocarbon, at least one halohydrocarbon, or combinations thereof. In a further aspect, the least one hydrocarbon or the least one halohydrocarbon can comprise an aliphatic hydrocarbon, an aromatic hydrocarbon, an aliphatic halohydrocarbon, an aromatic halohydrocarbon, or combinations thereof. Exemplary hydrocarbons useful in the foregoing solvent extraction systems for selective concentration of REEs include, but are not limited to, kerosene, mineral spirits, isoparaffin solvent (Isopar), xylene, toluene, benzene, pentane, hexane, heptane, nonane, decane, chloroform, or combinations thereof. In a further aspect, a LOPSES can comprise one or more REE and other metals. In a still further aspect, the other metals can comprise cobalt, nickel, or mixtures thereof. In an even further aspect, the other metals are present in trace amounts. In a yet further aspect, the one or more REEs can comprise one or more light REE and/or one or more heavy REE.

In various aspects, a LOPSES can be prepared by various methods for preparation of LOPSES from PLS have been recently described, including those disclosed in U.S. patent application Ser. Nos. 16/795,471, 17/115,128, and 17/706,584, as well as Intl. Pat. Appl. No. PCT/US2020/042674, filed May 9, 2022, each of which is incorporated herein by reference, particularly with reference to the methods of preparing a LOPSES from PLS (collectively referred to herein as “WVU REE/CM LOPSES processes”). The foregoing methods provide facile and high yield methods for the preparation of suitable LOPSESs from PLS, e.g., PLS prepared REE/CM pre-concentrate materials such comprise the concentrated REE/CMS (compared to the original source AMD, diminished gangue and other undesirable minerals or materials from the AMD, and providing the REE/CM pre-concentrate material, that is a useful feedstock for further enrichment and purification of REE/CMs such as the disclosed method described herein below. Other methods of preparing a suitable LOPSES from a suitable PLS comprising one or more REE/CM, e.g., a PLS prepared directly or indirectly from a REE/CM pre-concentrate or AMD material, may be known to the skilled artisan and can be utilized as a feedstock in the disclosed method described herein below.

A number of ligands are known that can be used in the foregoing solvent extraction systems for selective concentration of REEs. Representative, but non-limiting ligands (or as sometimes to referred to by the skilled artisan, “ligands”) include tributyl phosphate (TBP), carboxylic acids (e.g., Versatic Acid 10), phosphoric acid esters, phosphonic acid compounds, and phosphinic acid compounds. An exemplary phosphoric acid ester is di-2-ethylhexylphosphoric acid (D2EHPA), whereas an exemplary phosphonic acid compound is 2-ethylhexylphosphoric acid-mono-2-ethylhexyl ester (PC-88A by Daihachi Chemical Industry Co., Ltd.), and exemplary phosphinic acid compound an is bis(2,4,4-trimethylpentyl) phosphoric acid (Cyanex 272 by Cytec Industries). Further suitable examples of ligand useful in the foregoing solvent extraction systems for selective concentration of REEs are ligands such as 2-ethylhexyl phosphonic acid mono-2-ethylhexyl ester (EHEHPA), or esters of thiophosphinic acid, such as CYANEX 301, made by American Cyanamid, or mixtures of any of the above with any one or more of tributyl phosphate (TBP) or trioctylphosphine oxide (TOPO). These ligands are commercially available and commonly used.

A widely used organophosphorus ligand for use in the foregoing solvent extraction systems for selective concentration of REEs is bis(2-ethylhexyl) hydrogen phosphate, also known as di-(2-ethylhexyl) phosphoric acid, D2EHPA, HDEHP, DEHPA, or EHPA. It is marketed variously as HOSTAREX PA 216, DP-8R, and P-204. Bis (2-ethylhexyl) hydrogen phosphate is more acidic than carboxylic acids and can extract REE at significantly lower pH values than those used with neodecanoic or naphthenic acids, but it can also be difficult to strip. Various rare earths have been isolated using solvent extraction with bis(2-ethylhexyl) hydrogen phosphate, as disclosed by M. L. P. Reddy et al., in “Liquid-liquid Extraction Processes for the Separation and Purification of Rare Earths”, in Mineral Processing and Extractive Metallurgy, Review, vol. 12, pp. 91-113 (1995). Another organophosphorus reagent for solvent extraction of REEs is 2-ethylhexyl phosphonic acid mono-2-ethylhexyl ester (EHEHPA, HEHEHP), marketed variously as PC-88A, SME 418, P-507, and IONQUEST 801. This reagent has gained popularity for rare earth separations, less for its extractive abilities than for its relative ease of stripping compared to bis(2-ethylhexyl) hydrogen phosphate. A process for separating rare earths using 2-ethylhexyl phosphonic acid mono-2-ethylhexyl ester is disclosed in Fr. Demande No. 2460275 (1981), and several laboratory separations using this reagent are outlined by Reddy et al., supra.

It is also possible to use the ligands as disclosed and described in U.S. Pat. No. 9,133,100 which is incorporated herein by reference and includes REE ligands comprising a dialkyl diglycol amic acid having the general formula as follows:

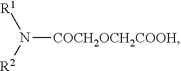

in which R¹ and R² are each independently alkyl, and at least one of R¹ and R² is a straight or branched alkyl group of at least 6 carbon atoms, preferably 6 to 18 carbon atoms, and more preferably 7 to 12 carbon atoms. If the carbon count is less than 6, the compound can fail to play the role of ligand because it is less lipophilic so that the organic phase lacks stability and exhibits poor separation from the aqueous phase, and because the dissolution of the ligand itself in aqueous phase becomes noticeable. On the other hand, an excessive carbon count contributes to no improvements in basic abilities like extraction and separation abilities despite the increased cost of ligand manufacture. In various aspects, the lipophilic nature is ensured, if one of R¹ and R² has a carbon count of at least 6, then the other may be of less than 6 carbon atoms. Suitable examples for use in the disclosed solvent extraction methods are those wherein two octyl (—C₈H₁₇) groups are introduced such as N,N-dioctyl-3-oxapentane-1,5-amic acid or dioctyl diglycol amic acid (DODGAA). A further suitable example for use in the disclosed solvent extraction methods are those wherein two 2-ethylhexyl (—CH₂CH(C₂H₅)C₄Hg) groups are introduced, which is named N,N-bis(2-ethylhexyl)-3-oxapentane-1,5-amic acid or di(2-ethylhexyl) diglycol amic acid (D2EHDGAA).

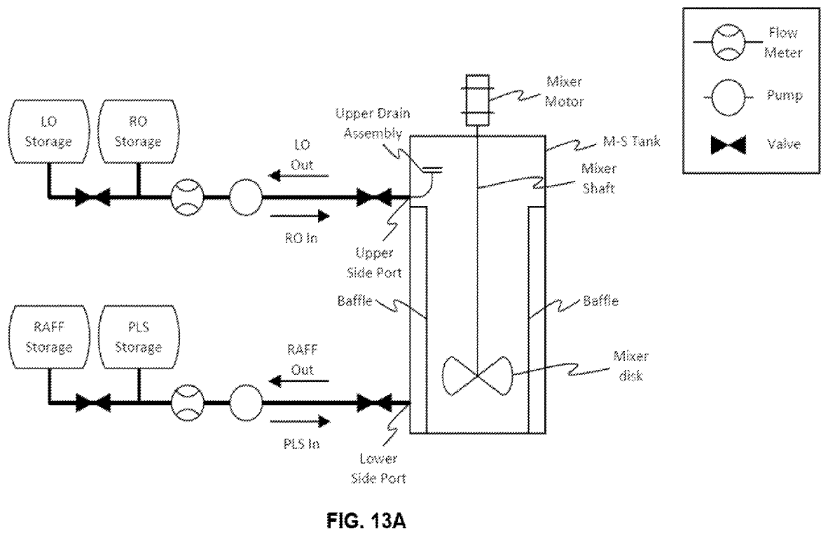

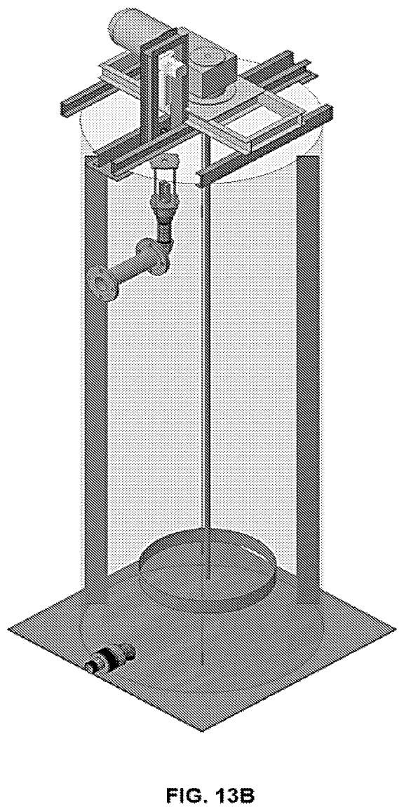

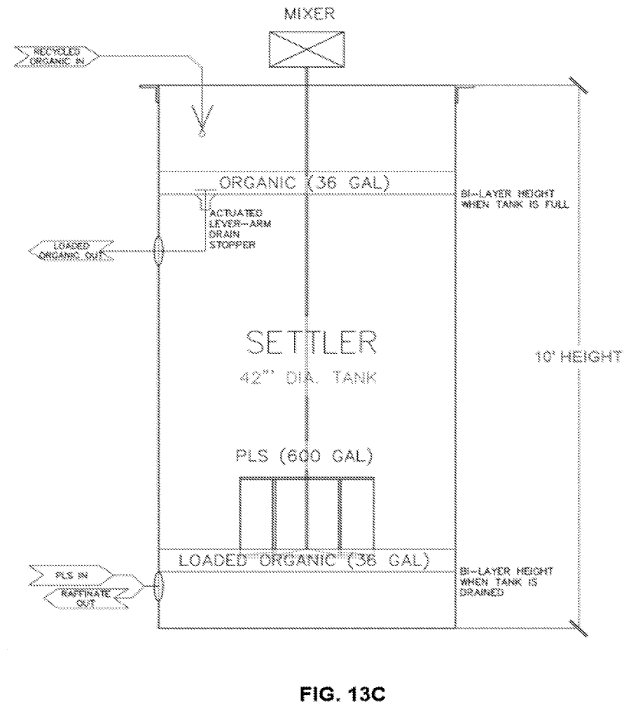

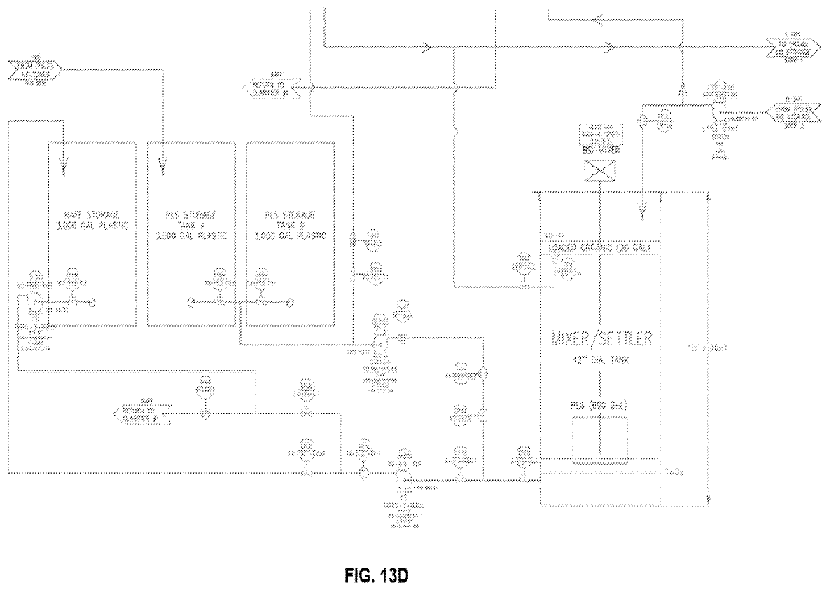

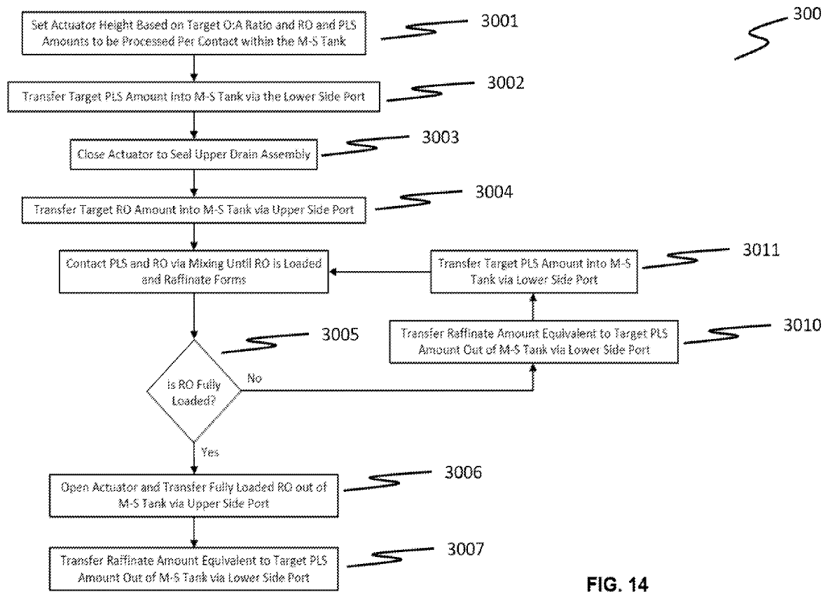

Referring now to FIGS. 13A-13D, these figures show representative schematic overviews of a process flow diagram of a disclosed process for batch solvent extraction of an input, e.g., a PLS material or composition, comprising a multi-port design and as depicted and further described in FIG. 14, and schematic representations of various aspects of the batch solvent extraction unit. FIG. 13A shows a process flow diagram using a multi-port design is useful for the extraction of a pregnant leach solution to prepare a disclosed loaded organic phase, i.e., preparation of a loaded organic phase from a solvent extraction system (LOPSES) as disclosed herein in which the loaded organic phase comprises an organic solvent and at least one REE and/or CM. That is, the depicted process unit operation is a representative disclosed process for preparation of a disclosed LOPSES process. FIG. 13B shows a representative three-dimensional rendering of an exemplary batch solvent extraction unit utilizing a three-port design, specifically the tank and various components associated with the tank. FIG. 13C shows a representative batch solvent extraction unit for a disclosed batch solvent extraction process utilizing a three-port design. FIG. 13C shows a representative batch solvent extraction flow schematic for a disclosed batch solvent extraction process. FIG. 13D shows an exemplary batch solvent extraction unit process flow schematic utilizing a three-port design with expanded network connection to other processing units and systems as disclosed herein.

Referring now to FIG. 14, which shows aspects of a disclosed process for batch solvent extraction of a pregnant leach solution used for the preparation of a disclosed loaded organic phase, i.e., preparation of a loaded organic phase from a solvent extraction system (LOPSES) as disclosed herein in which the loaded organic phase comprises an organic solvent and at least one REE and/or CM that is depicted in the schematic overviews of a process flow diagram of a disclosed process for batch solvent extraction of an input, e.g., a PLS material or composition, comprising a multi-port design and as depicted, and schematic representations of various aspects of the multi-port batch solvent extraction units, in FIGS. 13A-13D. That is, the depicted batch solvent extraction is a representative disclosed process for preparation of a LOPSES. Briefly, in operation, the process can comprise (3001) setting an actuator height based on a desired target O:A ratio, as well as RO and PLS amounts to be processed per contact within the M-S tank, followed by (3002) comprising the transfer of a target PLS amount into the M-S tank via a lower side port. Once the target PLS amount has been transferred, the actuator can be closed to seal the upper drain assembly as shown in (3003). Next, the target RO amount can be transferred into the M-S tank via an upper side port as shown in (3004). The PLS and RO are mixed until the RO is loaded and raffinate forms. If the RO is not fully loaded, then an amount of raffinate equivalent to the target PLS amount is removed via a lower side port (3010), and a target PLS amount is transferred into the M-S tank via a lower side port. If the RO is determined to be fully loaded (3005), then the actuator is opened and the fully loaded RO is transferred from the M-S tank via an upper side port (3006), followed by transfer of raffinate (in an amount equivalent to a desired target PLS amount) out of the M-S tank via a lower side port (3007).

In some aspects of the disclosed methods, PLS and RO can be mixed based on an retention time (typically between 10 and 15 minutes in the BSX). Because there are limited methods to assess in real time during active mixing if the RO has fully loaded with metals, i.e., that the PLS is depleted of the desired REE/CMs and rendering to raffinate, it is more practical to—based on a retention or mixing time of 10-15 minutes—to proceed as if the mixing has worked. Following the required separation time for the solution interfaces, the “raffinate” can be sampled and discarded. Sampling and experimental of analysis of the raffinate sample can be carried out using ICP analysis to assess the raffinate for the presence of the metals left in the aqueous solution post mixing. Thus, the user can assess if the operating condition of the extraction is working or not. If it there is concern that under operating conditions that the PLS has not been fully extracted, it can be stored and reextracted at a later time. Alternatively, or in combination with the foregoing, the pH of the raffinate solution can be assessed. In some aspects, the RO can be fully loaded when the raffinate pH decreases by 1 or 2 pH units.

In some aspects, the degree of loading of the RO can assessed in a method comprising carrying out a two step 6M HCl strip of the LO. Briefly, an equal volume of 6M HCl can be mixed with the LO for 4 hours and then used in laboratory analysis. This process is repeated once, thereby providing two HCl stripped samples—a first HCl stripped sample and a second sequential HCl stripped sample. Based on compositional analysis of these samples, the sum of the metals in the two aqueous assays allow determination of the metal composition in the LO. In various aspects, the RO has a loading capacity of from about 10-20 g/L, e.g. about 15 g/L+/−about 10%. If the sum of the metals present in a first HCl stripped sample and a second sequential HCl stripped sample is significantly less than the foregoing value for the RO, it can be concluded that the organic phase is not fully loaded.

In some aspects, adjustments in the procedure using the BSX can be based on the incoming PLS concentration and past tests to optimize the number of contacts and O:A ratio to load the organic. For example, if the raffinate results that indicate nearly 100% extraction of rare earths, then it can be concluded that the RO may not be entirely loaded. Alternatively, for example, if analysis of metal content determines that there is poor REE extraction, then it can be concluded that the RO is nearly fully loaded.

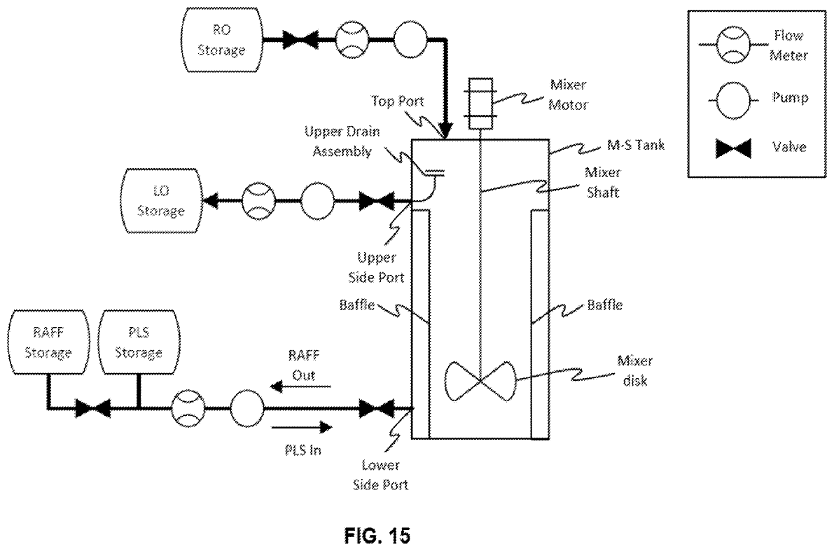

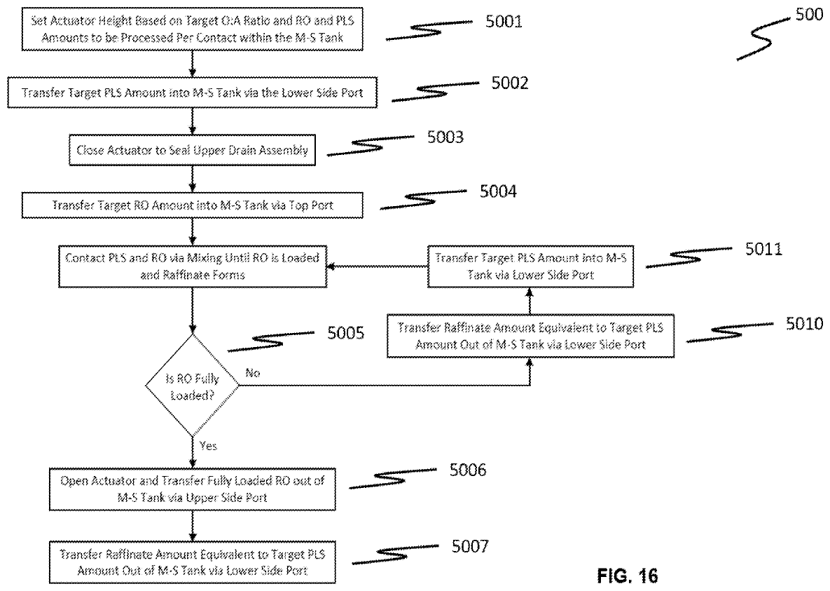

Referring now to FIG. 15, which shows a representative schematic overview of a process unit operation diagram of a disclosed process for batch solvent extraction of an input, e.g., a PLS material or composition, comprising a three-port design and as depicted and further described in FIG. 16. This is an alternative to the process unit operation diagram depicted in FIG. 13A. The process unit operation is useful for extraction of a pregnant leach solution to prepare a disclosed loaded organic phase, i.e., preparation of a loaded organic phase from a solvent extraction system (LOPSES) as disclosed herein in which the loaded organic phase comprises an organic solvent and at least one REE and/or CM. That is, the depicted batch solvent extraction carried using the process unit operation depicted is a representative disclosed process for preparation of a LOPSES.

Referring now to FIG. 16, which shows aspects of a disclosed process for batch solvent extraction of a pregnant leach solution used for the preparation of a disclosed loaded organic phase, i.e., preparation of a loaded organic phase from a solvent extraction system (LOPSES) as disclosed herein in which the loaded organic phase comprises an organic solvent and at least one REE and/or CM that is depicted in the process unit diagram in FIG. 15. That is, the depicted batch solvent extraction is a representative disclosed process for preparation of a LOPSES.

Briefly, in operation, the process can comprise (5001) comprising setting an actuator height based on a desired target O:A ratio, as well as RO and PLS amounts to be processed per contact within the M-S tank, followed by (5002) comprising the transfer of a target PLS amount into the M-Stank via a lower side port. Once the target PLS amount has been transferred, the actuator can be closed to seal the upper drain assembly as shown in (5003). Next, the target RO amount can be transferred into the M-S tank via a top port as shown in (5004). The PLS and RO are mixed until the RO is loaded and raffinate forms. If the RO is not fully loaded, then an amount of raffinate equivalent to the target PLS amount is removed via a lower side port (5010), and a target PLS amount is transferred into the M-S tank via a lower side port. If the RO is determined to be fully loaded (5005), then the actuator is opened and the fully loaded RO is transferred from the M-S tank via an upper side port (5006), followed by transfer of raffinate (in an amount equivalent to a desired target PLS amount) out of the M-S tank via a lower side port (5007).

### E. Disclosed Methods for Preparation of a Pregnant Leach Solution-Post Organic Extraction (PLS-LOPSES)

In one aspect, the present disclosure relates to methods for preparation of a PLS-LOPSES from a LOPSES. The LOPSES used in the disclosed methods is an organic solution or mixture enriched in one or more REE/CM. In a further aspect, the LOPSES comprises diminished gangue or raffinate materials compared to the upstream feedstock, e.g., AMD. As discussed herein above, the LOPSES can be from a suitable PLS comprising one or more REE/CM, e.g., a PLS prepared directly or indirectly from a REE/CM pre-concentrate or AMD material. Suitable PLS comprising one or more REE/CM prepared from a suitable feedstock, e.g., a REE/CM pre-concentrate material, can be prepared generally as discussed herein above. The REE/CM pre-concentrate material comprising one or more REE/CM can be prepared from a suitable feedstock, e.g., an AMD material, as described above.

The methods disclosed herein provide an alternative to more commonly used methods of back-extraction of a LOPSES. Briefly, the disclosed methods use solutions containing anions that precipitate the REEs, e.g., solutions containing oxalic acid, which are adjusted to specific pHs extract REEs and critical materials from the loaded organic phase to form insoluble oxalate salts. In a further aspect, the oxalate salts thus formed are metathesized to carbonate salts to recover oxalic acid and the carbonate salts are then solubilized with hydrochloric acid.

In various aspects, the disclosed systems and methods provide for recovery of critical materials from a LOPSES. In a further aspect, the disclosed processes and methods comprise stripping light REEs from the organic phase using oxalic acid in a first step, then stripping of the remaining heavy REEs with a mineral acid such as hydrochloric acid, metathesis of the light REE oxalate salts to carbonate salts with recovery of oxalic acid, and two processing steps to produce a PLS-LOPSES solution enriched with REEs. Concentrated solutions of oxalic acid can remove high percentage of light REEs from the LOPSES, e.g., greater than 50%, greater than 60%, greater than 70%, greater than 80%, or greater than 90% of the light REEs present initially in the LOPSES. Consequently, a smaller volume of hydrochloric acid is needed to remove the remaining heavy REEs. In one protocol, the excess hydrochloric acid is partially neutralized by carbonate from the metathesis system, reducing the amount of ammonium hydroxide needed in the final pH adjustment. This protocol reduces the amount of hydrochloric acid needed per kilogram of REEs obtained from the LOPSES. In another protocol, the excess hydrochloric acid containing the HREE is partially neutralized with ammonium hydroxide. The product obtained thusly is a pregnant leach solution, i.e., the PLS-LOPSES, that is enriched in REE chloride salts and is at a pH suitable for further processing and purification.

In a further aspect, in a first step, the LOPSES is mixed with a solution containing oxalic acid at a controlled pH. Light REEs in the organic phase are precipitated as oxalate salts in the aqueous phase. This step forms a partially stripped organic phase. The partially stripped organic phase is then mixed with a mineral acid, e.g., hydrochloric acid, in the second step. The second step enables extraction of the heavy REEs into an aqueous phase. This step forms a barren organic phase, i.e., an organic phase substantially stripped of REEs. The barren organic phase can be returned for re-use in the solvent extraction system. In a further aspect, the barren organic phase can optionally be further purified prior to re-use in the solvent extraction system. The light REE oxalates from the first step are mixed with sodium carbonate. The mixing of light REE carbonates with sodium carbonate forms REE-carbonates with recovery of oxalic acid. Either hydrochloric acid or the hydrochloric acid strip liquor from the second step is used to dissolve the carbonate salts from the first step and this step forms partially neutralized solutions containing either light and heavy REEs or TREEs. Adjustment of the solution pH can be performed using a suitable base, e.g., a hydroxide such as ammonium hydroxide.

In a further aspect, the disclosed methods for preparation of a pregnant leach solution-post organic extraction comprise: providing a loaded organic phase from a solvent extraction system (LOPSES) comprising an organic solvent and at least one REE; adding water and oxalic acid; mixing the water and the oxalic acid with the LOPSES, thereby forming a mixture comprising a partially stripped organic solvent and a slurry comprising a REE-oxalate precipitate and water; removing the partially stripped organic solvent from a slurry comprising the REE-oxalate precipitate and the water; and filtering the slurry in a filtration apparatus, thereby forming a retentate and a filtrate; wherein the organic solvent comprises at least one organic solvent; wherein the REE-oxalate precipitate comprises at least one REE; wherein the partially stripped organic solvent comprises at least one REE; wherein the retentate comprises a light REE-oxalate precipitate; and wherein the filtrate comprises water.

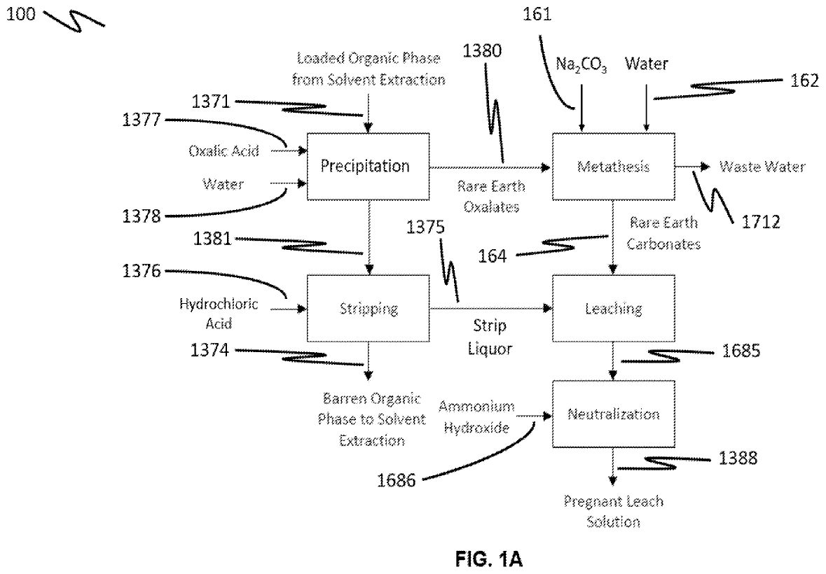

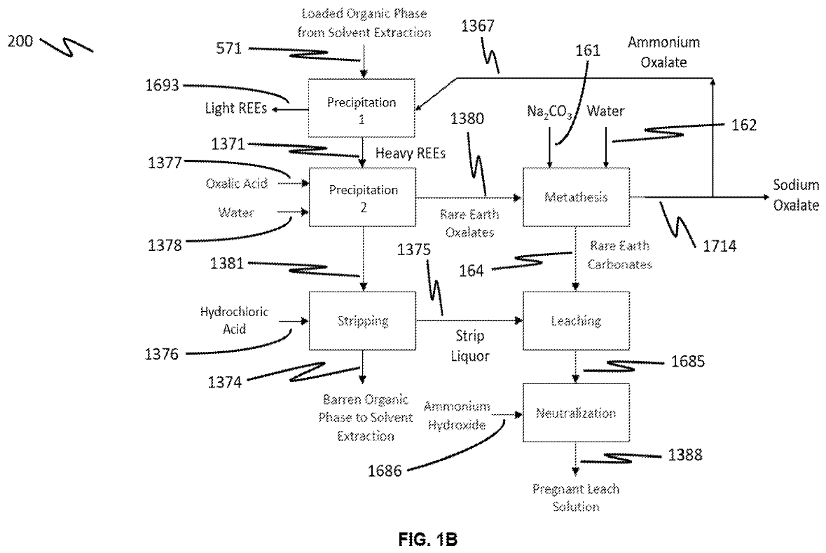

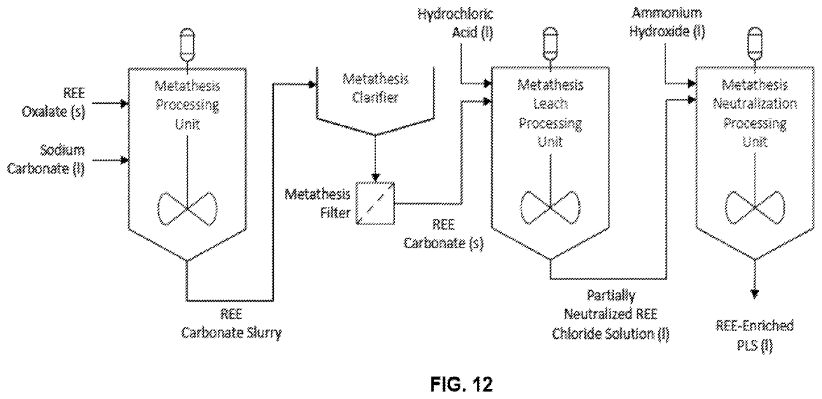

Referring now to FIG. 1A which shows aspects of a disclosed process 100 for preparation of a pregnant leach solution-post organic extraction from a loaded organic phase obtained from a solvent extraction system (LOPSES). A LOPSES (1371) is mixed with oxalic acid (H2C2O4) (1377) and water (1378). Light REEs in the organic phase are transferred to the aqueous phase and precipitated as oxalate salts. After separation of the aqueous and organic streams in the clarifier, the aqueous oxalate slurry (1380) is pumped to a filter and the solids collected by filter are pumped to the metathesis reactor (see FIG. 12). The partially stripped organic phase (1381) is sent to the stripping unit and mixed with hydrochloric acid (1376) plus any makeup organic phase. In the stripping unit, the remaining heavy REES in the organic phase are transferred to the hydrochloric acid solution. The stripped organic phase (1374) is returned to the solvent extraction system. The aqueous strip liquor (1375) is pumped to a metathesis leach reactor.

In the metathesis system (metathesis leach reactor), the light REE oxalates are mixed with sodium carbonate (161) and water (162). The solids are converted to carbonate salts. The solution containing the displaced oxalate is removed as wastewater. The REE carbonate slurry is pumped to the metathesis filter. The filtered solids (164) are pumped to the metathesis leach reactor and combined either with hydrochloric acid or with the aqueous strip liquor (1375). The hydrochloric acid is partially neutralized by carbonate, yielding an acidic solution containing REE chlorides. The REE chloride solution (1685) is sent to the metathesis neutralization tank and mixed with ammonium hydroxide (1686) to achieve the desired final pH of the pregnant leach solution (1388).

In various further aspects, the disclosed processes and methods comprise: (a) in the first step, a LOPSES is mixed with a solution comprising recycled ammonium oxalate or sodium oxalate, thereby precipitating from the organic phase light REEs in the aqueous phase and yielding a partially stripped organic phase; (b) the partially stripped organic phase is mixed with oxalic acid in a second step to extract middle REEs into an aqueous phase and forming a twice stripped organic phase; and (c) the twice stripped organic phase is mixed with a mineral acid (e.g., hydrochloric acid) in the third step to strip out the remaining HREEs and other metals and forming a barren organic phase. The barren organic phase can be returned to the solvent extraction system. The REE oxalates from the second stage are mixed in a metathesis unit or reactor with sodium carbonate to form REE carbonates therein. The released oxalate can be returned to the first stripping step either as the ammonium or the sodium salt. Hydrochloric acid is mixed with the REE carbonates from the metathesis unit to generate a partially neutralized leach solution containing mainly REEs. Additional neutralization is performed with ammonium hydroxide to produce a solution suitable for recycling to the pregnant leach solution.

In a further aspect, the disclosed methods for preparation of a pregnant leach solution-post organic extraction comprise: providing a loaded organic phase from a solvent extraction system (LOPSES) comprising an organic solvent and at least one REE; adding an aqueous oxalate solution; mixing the aqueous oxalate solution with the LOPSES, thereby forming a mixture comprising a partially stripped organic solvent and a first slurry comprising a first REE-oxalate precipitate and water; removing the partially stripped organic solvent from a first slurry; adding water and oxalic acid to the removed partially stripped organic solvent thereby forming a twice-stripped organic solvent and a second slurry comprising a second REE-oxalate precipitate and water; removing the twice-stripped organic solvent from the second slurry; filtering the first slurry in a first filtration apparatus, thereby forming a first retentate and a first filtrate; and filtering the second slurry in a second filtration apparatus, thereby forming a second retentate and a second filtrate; wherein the organic solvent comprises at least one organic solvent; wherein the first REE-oxalate precipitate comprises at least one REE; wherein the second REE-oxalate precipitate comprises at least one REE; wherein the partially stripped organic solvent comprises at least one REE; wherein the first retentate comprises a light REE-oxalate precipitate; wherein the second retentate comprises a heavy REE-oxalate precipitate; wherein the first filtrate comprises water; and wherein the second filtrate comprises water.

In a further aspect, a LOPSES is mixed with oxalate solution at a pH in the range of about 3 to 4. Under these conditions, light REEs are precipitated as oxalate salts. Middle and heavy REEs and yttrium remain in the organic phase. The organic phase is then mixed with a pure oxalic acid solution (pH ˜1.6). Under these conditions, middle REEs can be extracted as oxalate precipitates. The REE oxalates are converted to the corresponding carbonates in a concentrated sodium carbonate solution, thereby releasing the oxalates. The organic phase with HREEs and other metals can be quantitatively stripped of all metals in the stripping stage (step (c) above). The strip liquor is mixed with ammonium hydroxide to achieve partial neutralization of the excess hydrochloric acid. After raising the pH to a suitable value, the neutralized solution with some rare earths and other metals can be returned to the PLS feed stream for further processing in a solvent extraction system. In a further aspect, the foregoing achieves improved efficiency by recycling the oxalic acid as oxalate salt. In a still further aspect, the sodium oxalate salt solution can used in the first precipitation step (step (a) above). In another embodiment, the sodium cation can be replaced with the ammonium cation prior to the first precipitation step.

In various aspects, the foregoing disclosed system and method initially yields a stream of light rare earth oxalates. The light REEs may be the most abundant REEs present in the primary feedstock, e.g., the AMD used to prepare a pre-concentrate as discussed above and may comprise about 40-60 wt % of total REEs present in the primary feedstock. Yttrium can be co-extracted with REEs, and it may comprise up to about 15-35% of the total REEs. A further advantage of the foregoing disclosed system and method is that because of the low mass fractions of the heavy REEs, the system and method disclosed herein can recycle the heavy REEs back to the PLS feed for solvent extraction, thereby with each recycle back to the PLS feed for solvent extraction the concentrations of the heavy REEs increase such that they can be directly precipitated with oxalate solution in the first precipitation step.

Referring now to FIG. 1B which shows aspects of a disclosed process 200 for preparation of a pregnant leach solution-post organic extraction from a loaded organic phase obtained from a solvent extraction system (LOPSES).

In various aspects, a LOPSES (571) is mixed with ammonium oxalate or sodium oxalate solution (1367) in the first precipitation step. Precipitated REE oxalates, mainly the light REE oxalates, are removed into a light REE stream (1693) and are sent to a metathesis reactor as described for the second precipitation step. The partially stripped organic phase (1371) is pumped to the second precipitation step and mixed with streams comprising oxalic acid (1377) and water (1378). The twice-stripped organic phase (1381) is pumped to the final stripping step and mixed with hydrochloric acid (1376). The barren organic phase (1374) is returned to the solvent extraction system. The rare earth oxalates from the second precipitation step (1380) are pumped to the metathesis step and mixed with sodium carbonate and water (161 and 162, respectively). The released oxalate (1714) is either pumped back to the first precipitation step as a sodium salt or converted to an ammonium oxalate solution (1367) prior to returning to the first precipitation step. The rare earth carbonate (164) is pumped to a leach step and mixed with hydrochloric acid or the hydrochloric acid strip liquor (1375) from the stripping step. The partially neutralized mixture (1685) is pumped to a final neutralization stage and mixed with ammonium hydroxide (1686) to generate a middle REE-PLS-LOPSES stream (1388) to mix with pregnant leach solution (PLS).

### F. Aspects

The following listing of exemplary aspects supports and is supported by the disclosure provided herein.

Aspect 1. A method for preparation of a pregnant leach solution-post organic extraction, the method comprising: providing a loaded organic phase from a solvent extraction system (LOPSES) comprising an organic solvent and at least one REE; adding water and oxalic acid; mixing the water and the oxalic acid with the LOPSES, thereby forming a mixture comprising a partially stripped organic solvent and a slurry comprising a REE-oxalate precipitate and water; removing the partially stripped organic solvent from a slurry comprising the REE-oxalate precipitate and the water; and filtering the slurry in a filtration apparatus, thereby forming a retentate and a filtrate; wherein the organic solvent comprises at least one organic solvent; wherein the REE-oxalate precipitate comprises at least one REE; wherein the partially stripped organic solvent comprises at least one REE; wherein the retentate comprises a light REE-oxalate precipitate; and wherein the filtrate comprises water.

Aspect 2. The method of Aspect 1, wherein the organic solvent comprises at least one hydrocarbon, at least one halohydrocarbon, or combinations thereof.

Aspect 3. The method of Aspect 2, wherein the least one hydrocarbon or the least one halohydrocarbon comprises an aliphatic hydrocarbon, an aromatic hydrocarbon, an aliphatic halohydrocarbon, an aromatic halohydrocarbon, or combinations thereof.

Aspect 4. The method of Aspect 2, wherein the hydrocarbon comprises kerosene, mineral spirits, isoparaffin solvent (Isopar), xylene, toluene, benzene, pentane, hexane, heptane, nonane, decane, chloroform, or combinations thereof.

Aspect 5. The method of any one of 1-Aspect 4, wherein the LOPSES further comprises at least one ligand for a REE.

Aspect 6. The method of Aspect 5, wherein the ligand comprises a dialkyl diglycol amic acid, a dialkyl phosphate, a trialkyl phosphate, a carboxylic acid, a phosphoric acid ester, a phosphonic acid, a phosphinic acid, or combinations thereof.

Aspect 7. The method of Aspect 6, wherein the ligand comprises di-2-ethylhexylphosphoric acid (D2EHPA), 2-ethylhexyl phosphate, bis(2-ethylhexyl) phosphate (HDEHPA), 2-ethylhexylphosphoric acid-mono-2-ethylhexyl ester (HEH/EHP), bis(2,4,4-trimethylpentyl)phosphoric acid, dibutryl phosphate, tributyl phosphate (TBP), N,N-dioctyl-3-oxapentane-1,5-amic acid (DODGAA), N,N-bis(2-ethylhexyl)-3-oxapentane-1,5-amic acid (D2EHDGAA), or combinations thereof.

Aspect 8. The method of any one of 1-Aspect 6, wherein the LOPSES is present in a LOPSES volume; and wherein adding water and oxalic acid to the LOPSES comprises adding a volume of water that is from about 0.5-fold to about 5.0-fold of the LOPSES volume.

Aspect 9. The method of Aspect 8, wherein the adding water and oxalic acid to the LOPSES comprises adding an amount of oxalic acid that is from about 10 g/L oxalic acid to about 100 g/L oxalic acid based on a volume of water added to the LOPSES.

Aspect 10. The method of any one of 1-Aspect 9, wherein the adding water and oxalic acid to the LOPSES comprises forming a solution of the water and the oxalic acid prior to adding to the LOPSES.

Aspect 11. The method of Aspect 10, further comprising adjusting pH of the solution of the water and the oxalic acid, wherein adjusting the pH is adding a base in an amount sufficient for the pH to be from about 1.5 to about 2.0.

Aspect 12. The method of Aspect 10, further comprising adjusting pH of the solution of the water and the oxalic acid, wherein adjusting the pH is adding a base in an amount sufficient for the pH to be from about 2.0 to about 3.0.

Aspect 13. The method of Aspect 10, further comprising adjusting pH of the solution of the water and the oxalic acid, wherein adjusting the pH is adding a base in an amount sufficient for the pH to be from about 3.0 to about 4.0.

Aspect 14. The method of any one of 1-Aspect 13, wherein the base is a carbonate, an oxide, a hydroxide, or combinations thereof.

Aspect 15. The method of Aspect 14, wherein the base is an oxide, a hydroxide, or combinations thereof.

Aspect 16. The method of Aspect 14, wherein the oxide is calcium oxide.

Aspect 17. The method of Aspect 14, wherein the hydroxide is sodium hydroxide, potassium hydroxide, ammonium hydroxide, or combinations thereof.

Aspect 18. The method of any one of 1-Aspect 13, wherein the REE-oxalate precipitate comprises at least one light REE-oxalate precipitate.

Aspect 19. The method of any one of 1-Aspect 13, wherein the REE-oxalate precipitate comprises a mixture of at least one light REE-oxalate precipitate and at least one heavy REE-oxalate precipitate.

Aspect 20. The method of any one of 1-Aspect 19, wherein the removing the partially stripped organic solvent from the slurry comprises uses a clarifier.

Aspect 21. The method of Aspect 20, wherein the slurry comprising a REE-oxalate precipitate and water is pumped from the clarifier to the filtration apparatus.

Aspect 22. The method of any one of 1-Aspect 21, further comprising adding a mineral acid to the partially stripped organic solvent, thereby forming a stripped organic phase and an aqueous strip liquor; and wherein the aqueous strip liquor comprises at least one heavy REE.

Aspect 23. The method of Aspect 22, wherein the mineral acid comprises hydrochloric acid, nitric acid, sulfuric acid, or combinations thereof.

Aspect 24. The method of Aspect 23, wherein the mineral acid comprises hydrochloric acid, nitric acid, or combinations thereof.

Aspect 25. The method of Aspect 23, wherein the mineral acid comprises hydrochloric acid.

Aspect 26. The method of Aspect 25, wherein the hydrochloric acid has a molarity from about 3 M to about 12 M.

Aspect 27. The method of Aspect 23, wherein the mineral acid comprises nitric acid.

Aspect 28. The method of Aspect 27, wherein the hydrochloric acid has a molarity from about 3 M to about 16 M.

Aspect 29. The method of Aspect 23, wherein the mineral acid comprises sulfuric acid.

Aspect 30. The method of Aspect 29, wherein the sulfuric acid has a molarity from about 3 M to about 18 M.

Aspect 31. The method of any one of 1-Aspect 30, further comprising removing the retentate to a metathesis reactor.

Aspect 32. The method of Aspect 31, wherein sodium carbonate and water are mixed with the retentate, thereby forming a carbonate mixture comprising a light REE-carbonate precipitate and a wastewater; wherein the light REE-carbonate precipitate comprises at least one light REE; and wherein the wastewater comprises oxalate.

Aspect 33. The method of Aspect 32, further comprising filtering the carbonate mixture in a metathesis filtration apparatus, thereby forming a metathesis retentate and a metathesis filtrate.

Aspect 34. The method of Aspect 33, further comprising combining the metathesis retentate with the aqueous strip of Aspect 22, thereby forming REE salt solution comprising water, at least one light REE salt, and at least one heavy REE salt.

Aspect 35. The method of Aspect 34, wherein the REE salt solution comprises water, at least one light REE chloride salt, and at least one heavy REE chloride salt.

Aspect 36. The method of Aspect 34, wherein the REE salt solution is conveyed to a metathesis neutralization tank; and wherein a base is mixed with the REE salt solution.

Aspect 37. The method of Aspect 36, wherein the base is ammonium hydroxide.

Aspect 38. The method of Aspect 37, wherein the ammonium hydroxide has a concentration from about 1 M to about 15 M.

Aspect 39. The method of any one of 1-Aspect 38, wherein the pregnant leach solution-post organic extraction comprises at least one of lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration.

Aspect 40. The method of Aspect 39, wherein the total rare earth concentration is about 5 mg/L to about 100 g/L.

Aspect 41. The method of Aspect 40, wherein the total rare earth concentration is about 1 g/L to about 100 g/L.

Aspect 42. The method of Aspect 40, wherein the total rare earth concentration is about 10 g/L to about 100 g/L.

Aspect 43. The method of Aspect 40, wherein the total rare earth concentration is about 20 g/L to about 70 g/L.

Aspect 44. The method of Aspect 40, wherein the total rare earth concentration is about 30 g/L to about 60 g/L.

Aspect 45. The method of Aspect 40, wherein the total rare earth concentration is about 5 mg/L to about 500 mg/L.

Aspect 46. The method of Aspect 40, wherein the total rare earth concentration is about 50 mg/L to about 500 mg/L.

Aspect 47. The method of Aspect 40, wherein the total rare earth concentration is about 100 mg/L to about 500 mg/L.

Aspect 48. A pregnant leach solution-post organic extraction prepared by the method of any one of 1-Aspect 47.

Aspect 49. A method for preparation of a pregnant leach solution-post organic extraction, the method comprising: providing a loaded organic phase from a solvent extraction system (LOPSES) comprising an organic solvent and at least one REE; adding an aqueous oxalate solution; mixing the aqueous oxalate solution with the LOPSES, thereby forming a mixture comprising a partially stripped organic solvent and a first slurry comprising a first REE-oxalate precipitate and water; removing the partially stripped organic solvent from a first slurry; adding water and oxalic acid to the removed partially stripped organic solvent thereby forming a twice-stripped organic solvent and a second slurry comprising a second REE-oxalate precipitate and water; removing the twice-stripped organic solvent from the second slurry; filtering the first slurry in a first filtration apparatus, thereby forming a first retentate and a first filtrate; and filtering the second slurry in a second filtration apparatus, thereby forming a second retentate and a second filtrate; wherein the organic solvent comprises at least one organic solvent; wherein the first REE-oxalate precipitate comprises at least one REE; wherein the second REE-oxalate precipitate comprises at least one REE; wherein the partially stripped organic solvent comprises at least one REE; wherein the first retentate comprises a light REE-oxalate precipitate; wherein the second retentate comprises a heavy REE-oxalate precipitate; wherein the first filtrate comprises water; and wherein the second filtrate comprises water.

Aspect 50. The method of Aspect 49, wherein the organic solvent comprises at least one hydrocarbon, at least one halohydrocarbon, or combinations thereof.

Aspect 51. The method of Aspect 50, wherein the least one hydrocarbon or the least one halohydrocarbon comprises an aliphatic hydrocarbon, an aromatic hydrocarbon, an aliphatic halohydrocarbon, an aromatic halohydrocarbon, or combinations thereof.

Aspect 52. The method of Aspect 50, wherein the hydrocarbon comprises kerosene, mineral spirits, isoparaffin solvent (Isopar), xylene, toluene, benzene, pentane, hexane, heptane, nonane, decane, chloroform, or combinations thereof.

Aspect 53. The method of any one of Aspect 49-Aspect 52, wherein the LOPSES further comprises at least one ligand for a REE.

Aspect 54. The method of Aspect 53, wherein the ligand comprises a dialkyl diglycol amic acid, a dialkyl phosphate, a trialkyl phosphate, a carboxylic acid, a phosphoric acid ester, a phosphonic acid, a phosphinic acid, or combinations thereof.

Aspect 55. The method of Aspect 54, wherein the ligand comprises di-2-ethylhexylphosphoric acid (D2EHPA), 2-ethylhexyl phosphate, bis(2-ethylhexyl) phosphate (HDEHPA), 2-ethylhexylphosphoric acid-mono-2-ethylhexyl ester (HEH/EHP), bis(2,4,4-trimethylpentyl)phosphoric acid, dibutryl phosphate, tributyl phosphate, N,N-dioctyl-3-oxapentane-1,5-amic acid (DODGAA), N,N-bis(2-ethylhexyl)-3-oxapentane-1,5-amic acid (D2EHDGAA), or combinations thereof.

Aspect 56. The method of any one of Aspect 49-Aspect 55, wherein the LOPSES is present in a LOPSES volume; and wherein the adding aqueous oxalate solution comprises adding a volume of aqueous oxalate solution that is from about 0.5-fold to about 5.0-fold of the LOPSES volume.

Aspect 57. The method of Aspect 56, wherein the aqueous oxalate solution has an oxalate concentration from about 10 g/L oxalic acid to about 100 g/L oxalic acid based on the volume of the aqueous oxalate solution.

Aspect 58. The method of Aspect 56 or Aspect 57, wherein the oxalate is derived from oxalic acid, sodium oxalate, potassium oxalate, ammonium oxalate, or a mixture thereof.

Aspect 59. The method of Aspect 58, wherein the oxalate is derived from oxalic acid, sodium oxalate, ammonium oxalate, or a mixture thereof.

Aspect 60. The method of Aspect 58, wherein the oxalate is derived from oxalic acid, sodium oxalate, or mixture thereof.

Aspect 61. The method of Aspect 58, wherein the oxalate is derived from oxalic acid, ammonium oxalate, or a mixture thereof.

Aspect 62. The method of any one of Aspect 49-Aspect 61, wherein the removed partially stripped organic solvent is present in a removed partially stripped organic solvent volume; and wherein adding water and oxalic acid to the removed partially stripped organic solvent comprises adding a volume of water that is from about 0.5-fold to about 5.0-fold of the removed partially stripped organic solvent volume.

Aspect 63. The method of Aspect 62, wherein the adding water and oxalic acid to the removed partially stripped organic solvent comprises adding an amount of oxalic acid that is from about 10 g/L oxalic acid to about 100 g/L oxalic acid based on a volume of water added to the LOPSES.

Aspect 64. The method of Aspect 62 or Aspect 63, wherein the adding water and oxalic acid to the removed partially stripped organic solvent comprises forming a solution of the water and the oxalic acid prior to adding to the removed partially stripped organic solvent.

Aspect 65. The method of Aspect 64, further comprising adjusting pH of the solution of the water and the oxalic acid, wherein adjusting the pH is adding a base in an amount sufficient for the pH to be from about 1.5 to about 2.0.

Aspect 66. The method of Aspect 64, further comprising adjusting pH of the solution of the water and the oxalic acid, wherein adjusting the pH is adding a base in an amount sufficient for the pH to be from about 2.0 to about 3.0.

Aspect 67. The method of Aspect 64, further comprising adjusting pH of the solution of the water and the oxalic acid, wherein adjusting the pH is adding a base in an amount sufficient for the pH to be from about 3.0 to about 4.0.

Aspect 68. The method of any one of Aspect 65-Aspect 67, wherein the base is a carbonate, an oxide, a hydroxide, or combinations thereof.

Aspect 69. The method of Aspect 68, wherein the base is an oxide, a hydroxide, or combinations thereof.

Aspect 70. The method of Aspect 68, wherein the oxide is calcium oxide.

Aspect 71. The method of Aspect 68, wherein the hydroxide is sodium hydroxide, potassium hydroxide, ammonium hydroxide, or combinations thereof.

Aspect 72. The method of any one of Aspect 49-Aspect 71, wherein the first REE-oxalate precipitate comprises a mixture of at least one light REE-oxalate precipitate and at least one heavy REE-oxalate precipitate.

Aspect 73. The method of any one of Aspect 49-Aspect 72, wherein the removing the partially stripped organic solvent from the first slurry comprises uses a first clarifier.

Aspect 74. The method of Aspect 73, wherein the first slurry comprising the first REE-oxalate precipitate and water is pumped from the first clarifier to the first filtration apparatus.

Aspect 75. The method of any one of Aspect 49-Aspect 73, wherein the removing the twice-stripped organic solvent from the second slurry comprises using a second clarifier.

Aspect 76. The method of Aspect 75, wherein the second slurry comprising the second REE-oxalate precipitate and water is pumped from the second clarifier to the second filtration apparatus.

Aspect 77. The method of any one of Aspect 49-Aspect 76, further comprising adding a mineral acid to the twice-stripped organic solvent, thereby forming a barren organic phase and an aqueous strip liquor.

Aspect 78. The method of Aspect 77, wherein the mineral acid comprises hydrochloric acid, nitric acid, sulfuric acid, or combinations thereof.

Aspect 79. The method of Aspect 78, wherein the mineral acid comprises hydrochloric acid.

Aspect 80. The method of any one of Aspect 77-Aspect 83, wherein the mineral acid has a molarity from about 3 M to about 12 M.

Aspect 81. The method of Aspect 78, wherein the mineral acid comprises nitric acid.

Aspect 82. The method of any one of Aspect 77-Aspect 83, wherein the nitric acid has a molarity from about 3 M to about 16 M.

Aspect 83. The method of Aspect 78, wherein the mineral acid comprises sulfuric acid.

Aspect 84. The method of any one of Aspect 77-Aspect 83, wherein the mineral acid has a molarity from about 3 M to about 18 M.

Aspect 85. The method of any one of Aspect 49-Aspect 84, further comprising removing the second retentate to a metathesis reactor.

Aspect 86. The method of Aspect 85, wherein sodium carbonate and water are mixed with the second retentate, thereby forming a mixture comprising a heavy REE-carbonate precipitate and an oxalate.

Aspect 87. The method of Aspect 86, further comprising combining the metathesis retentate with the aqueous strip of Aspect 77, thereby forming REE salt solution comprising water, at least one heavy REE-carbonate.

Aspect 88. The method of Aspect 87, wherein the REE salt solution is conveyed to a metathesis neutralization tank; and wherein a base is mixed with the REE salt solution.

Aspect 89. The method of Aspect 88, wherein the base is ammonium hydroxide.

Aspect 90. The method of Aspect 82, wherein the ammonium hydroxide has a concentration from about 1 M to about 15 M.

Aspect 91. The method of any one of Aspect 49-Aspect 90, wherein the pregnant leach solution-post organic extraction comprises at least one of lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration.

Aspect 92. The method of Aspect 91, wherein the total rare earth concentration is about 5 mg/L to about 100 g/L.

Aspect 93. The method of Aspect 92, wherein the total rare earth concentration is about 50 mg/L to about 500 mg/L.

Aspect 94. The method of Aspect 92, wherein the total rare earth concentration is about 1 g/L to about 100 g/L.

Aspect 95. The method of Aspect 92, wherein the total rare earth concentration is about 10 g/L to about 100 g/L.

Aspect 96. The method of Aspect 92, wherein the total rare earth concentration is about 20 g/L to about 70 g/L.

Aspect 97. The method of Aspect 92, wherein the total rare earth concentration is about 30 g/L to about 60 g/L.

Aspect 98. The method of Aspect 92, wherein the total rare earth concentration is about 5 mg/L to about 500 mg/L.

Aspect 99. The method of Aspect 92, wherein the total rare earth concentration is about 50 mg/L to about 500 mg/L.

Aspect 100. The method of Aspect 92, wherein the total rare earth concentration is about 100 mg/L to about 500 mg/L.

Aspect 101. A pregnant leach solution-post organic extraction prepared by the method of any one of Aspect 49-Aspect 100.

From the foregoing, it will be seen that aspects herein are well adapted to attain all the ends and objects hereinabove set forth together with other advantages which are obvious, and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### G. Examples

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Disclosed Oxalic Acid-Based Extraction Method for Preparation of a Disclosed Pregnant Leach Solution-Post Organic Extraction (PLS-LOPSES) Product (Example Method 1A). The method is described in FIG. 1A. The method comprises stripping first light REEs from the organic phase using oxalic acid, stripping of the remaining heavy REEs with hydrochloric acid, metathesis of the light REE oxalate salts to carbonate salts with recovery of oxalic acid, and two processing steps to produce a pregnant leach solution enriched with REEs. The first step uses the acidic stripping liquor from the second stripping step to dissolve the carbonate salts and the second step uses ammonium hydroxide to adjust the pH. The final product is a PLS-LOPSES enriched in REE chloride salts at a pH suitable for subsequent processing and separation steps.

Briefly, concentrated solutions of oxalic acid can remove about 90% of light REEs (lanthanum to terbium) from a LOPSES. Consequently, a smaller volume of hydrochloric acid can be used to remove the remaining heavy REEs (yttrium, dysprosium to lutetium). Moreover, the excess hydrochloric acid is able to partially neutralize the product from the metathesis step (with carbonate), thereby reducing the amount of ammonium hydroxide ultimately necessary in the final pH adjustment step. The method comprises use of consumables such as sodium carbonate, hydrochloric acid and ammonium hydroxide.

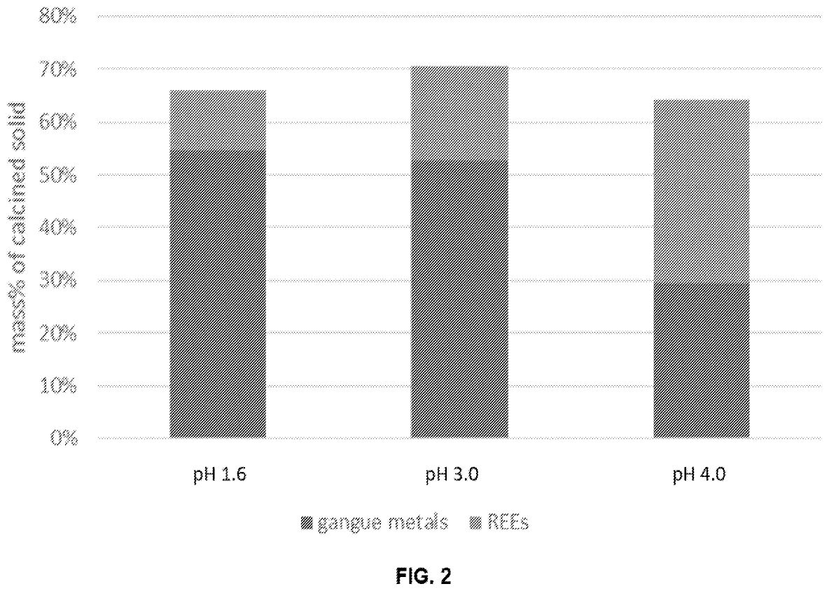

In this example, three aqueous solutions, each containing 40 milliliters of 40 g/L of oxalic acid, were combined with 40 mL of LOPSES. The first solution comprised oxalic acid without further pH adjustment (i.e., having a pH=1.6); the second oxalic acid solution was adjusted to pH 3.0 using sodium hydroxide; and the third oxalic acid solution was adjusted to pH 4.0 using sodium hydroxide. After 12 hours of mixing, the organic phase was separated from the aqueous suspension of oxalate salts and stripped with an equal volume of 6 M (18%) hydrochloric acid. The oxalate solids were collected, washed with water, calcined at 600° C., weighed, and re-dissolved in dilute nitric acid. Analysis of the aqueous solutions yielded the results shown in FIGS. 2-5. In other experiments, it was determined that substitution of 6 M hydrochloric acid solution (18%) as described above with 12 M hydrochloric acid (37%), or 3 M (12%) yielded equivalent concentrations of all elements stripped from the loaded organic phase except yttrium. It was further determined that the percentage of yttrium extracted decreased as the hydrochloric acid concentration decreased. Thus, in various aspects, a more dilute and less expensive HCl concentration could be used in the disclosed methods if yttrium recovery was not a major production goal.

The LOPSES used in the above method was initially prepared using as 65% Elixore 205 (Total Special Fluids, Inc., Houston, TX), 25% D2EHPA and 10% TBP by volume. The LOPSES comprised the concentrations of REE/CMs as shown below in Table 2 below. Scandium concentrations were at trace levels and not included in the table below.

TABLE 2
LOPSES REE/CMs.

| Element | concentration (mg/L) |
|---|---|
| Yttrium | 1010 |
| Lanthanum | 170 |
| Cerium | 450 |
| Praseodymium | 100 |
| Neodymium | 550 |
| Samarium | 170 |
| Europium | 43 |
| Gadolinium | 230 |
| Terbium | 35 |
| Dysprosium | 180 |
| Holmium | 35 |
| Erbium | 84 |
| Thulium | 11 |
| Ytterbium | 50 |
| Lutetium | 6 |
| Total REEs | 3100 mg/L |

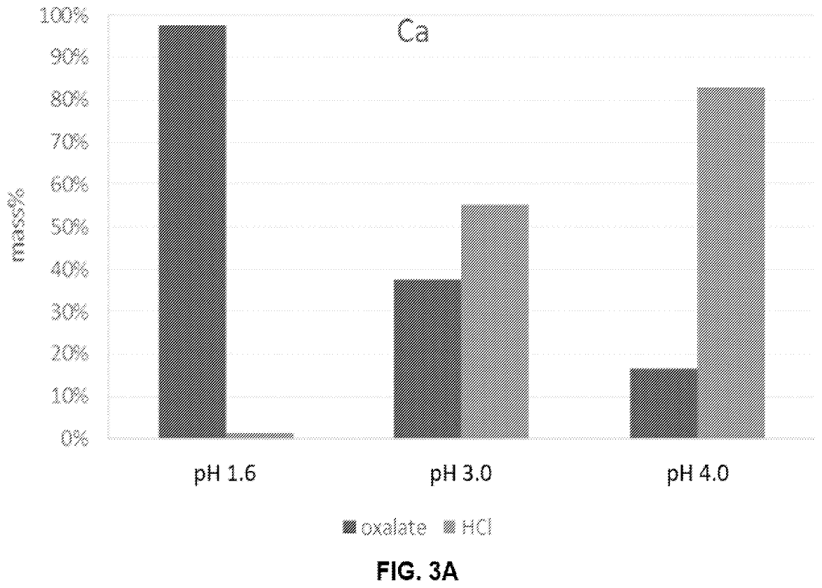

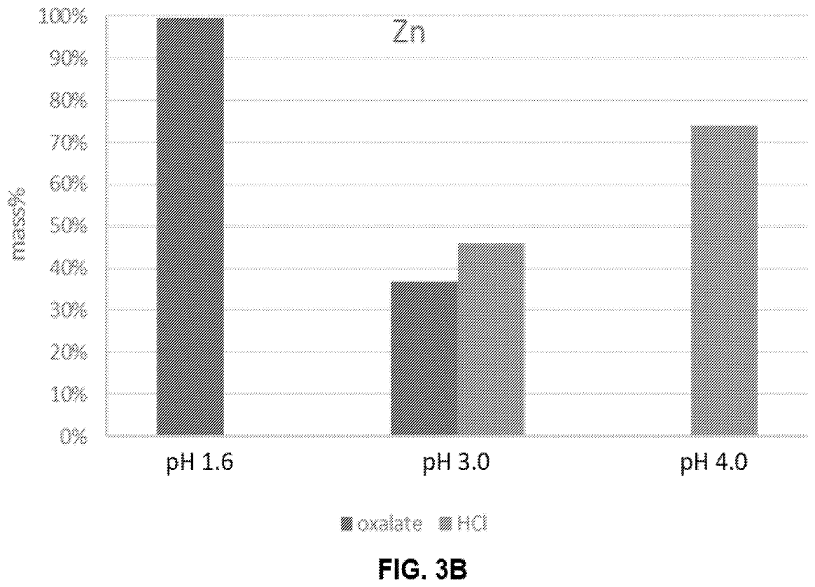

The masses of the calcined salts decreased with increasing pH of the oxalic acid salt: 684 mg at pH 1.4, 280 mg at pH 3.0 and 107 mg at pH 4.0. As shown in FIG. 2, the composition of the calcined salts included 55%, 53% and 30% of gangue metals (principally calcium and zinc) and 11%, 18% and 35% of REE metals. Using the known loading of the organic phase, mass balances for the oxalate and HCl stripping steps demonstrated that the percent of calcium and zinc extracted from the organic phase dropped dramatically with increasing pH (FIGS. 3A-3B). This trend accounted for the decreasing masses of the calcined salts.

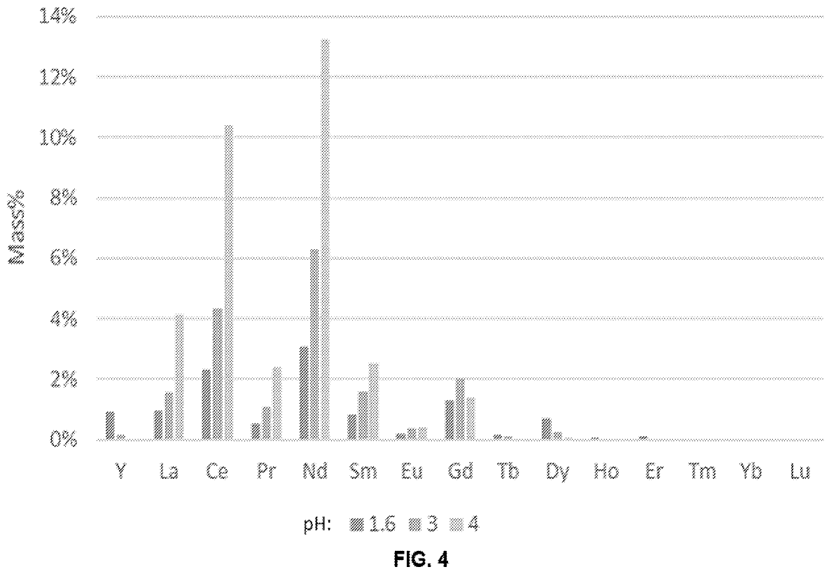

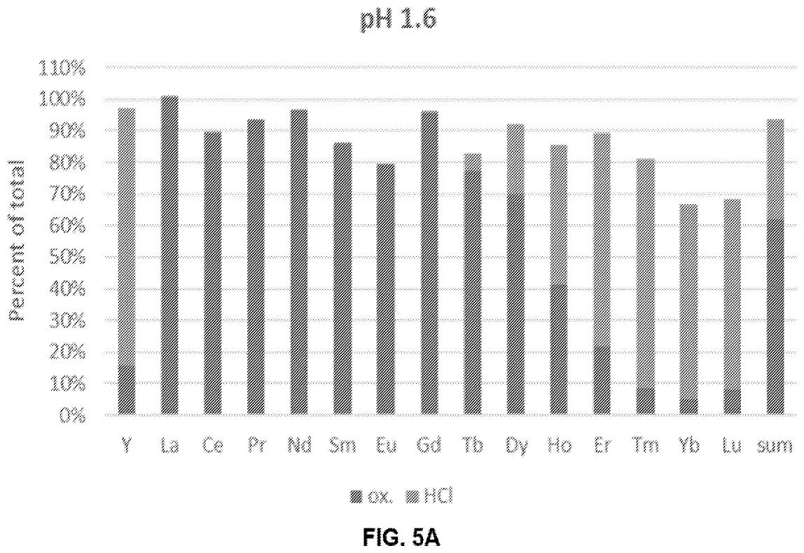

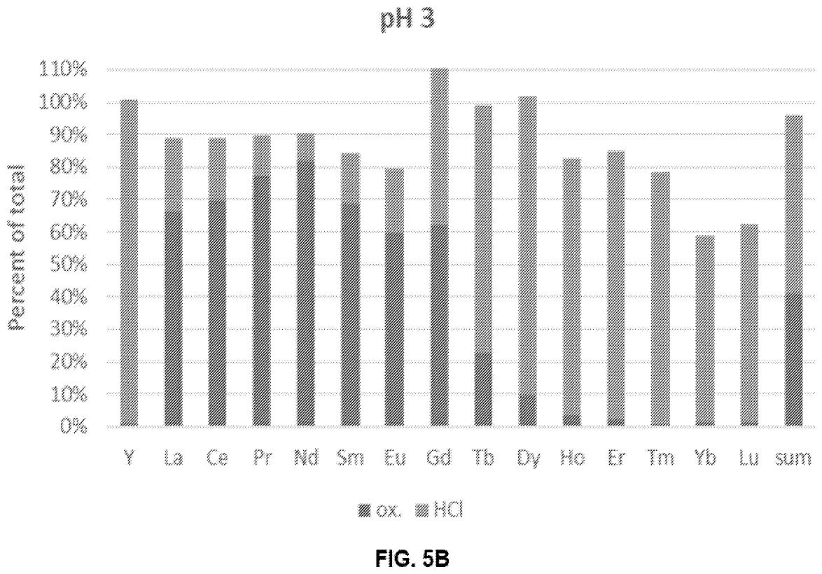

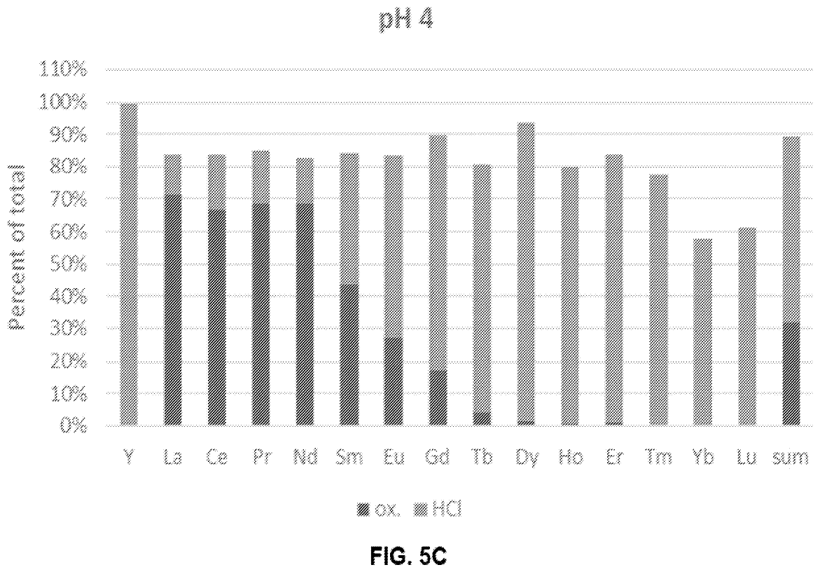

Light REEs were extracted into the oxalic acid solution as shown by analysis of the calcined solid. The mass % of most of the light rare earth elements in the calcined solids increased markedly with pH (FIG. 4). Mass balances for each REE yielded the percentage of each element extracted from the organic phase into the oxalate solution and the hydrochloric acid solution (FIGS. 5A-5C). At each of the three pH values examined, the light REEs were extracted with high efficiency into the oxalate solution. The data show that as the pH increased, the transition from preferred extraction into oxalic acid to preferred extraction into HCl shifted to the left (REEs with lower atomic weights). Accordingly, the disclosed method provides modulation of the oxalic acid pH used in the extraction step to provide fine control over the distribution of light and heavy REEs in the oxalate extraction, as well as the amounts of calcium and zinc present in the oxalate extraction.

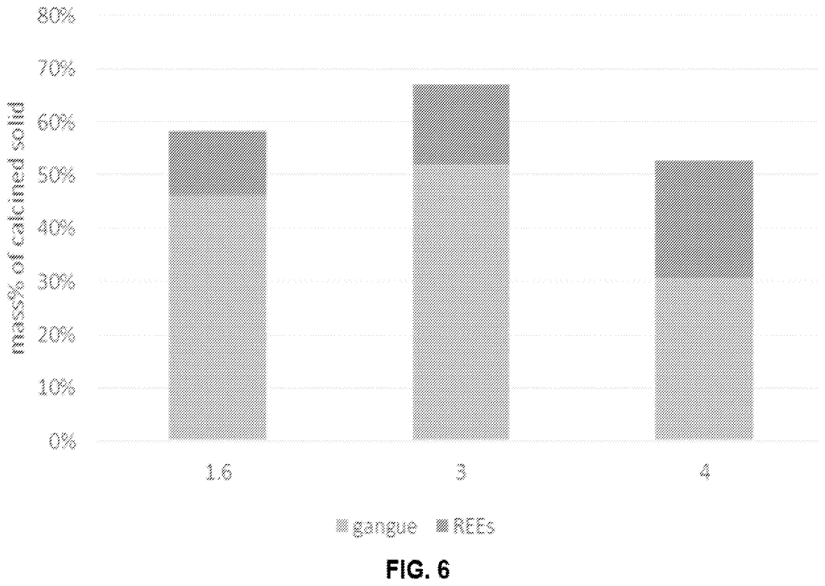

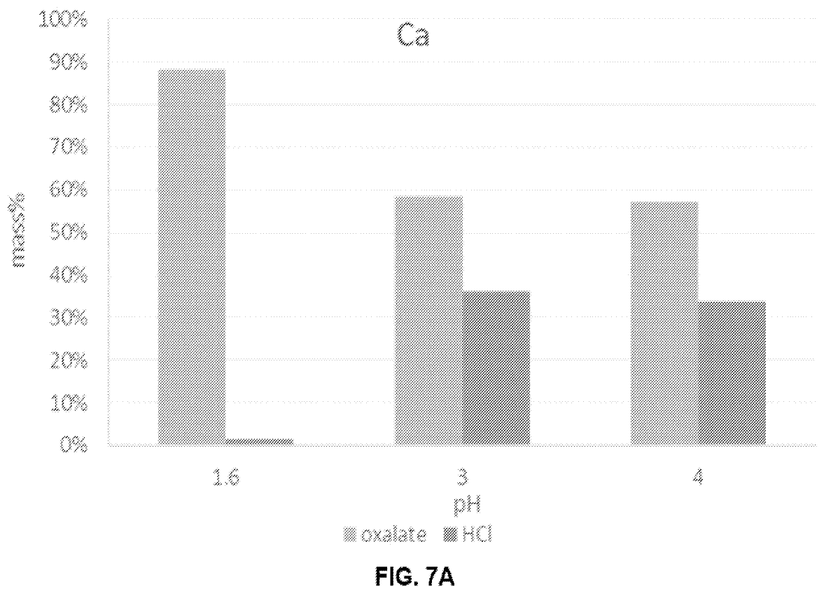

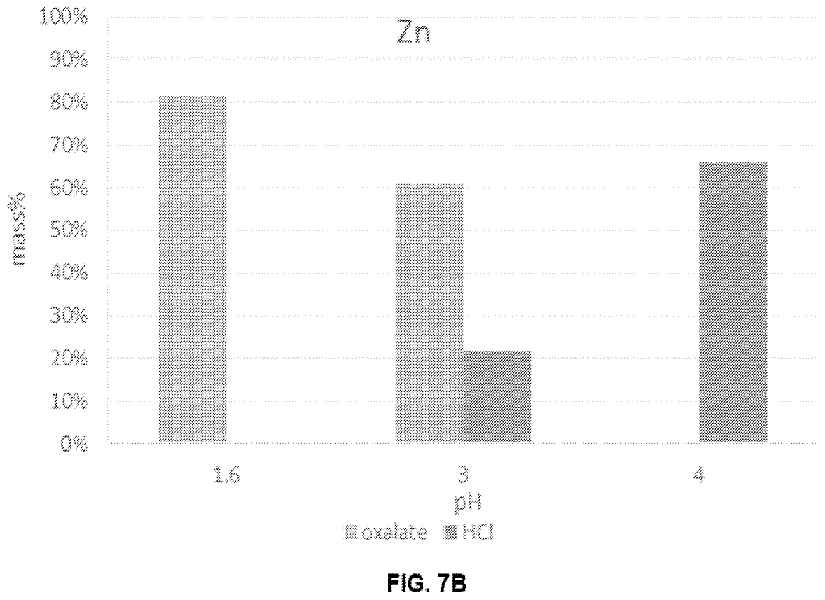

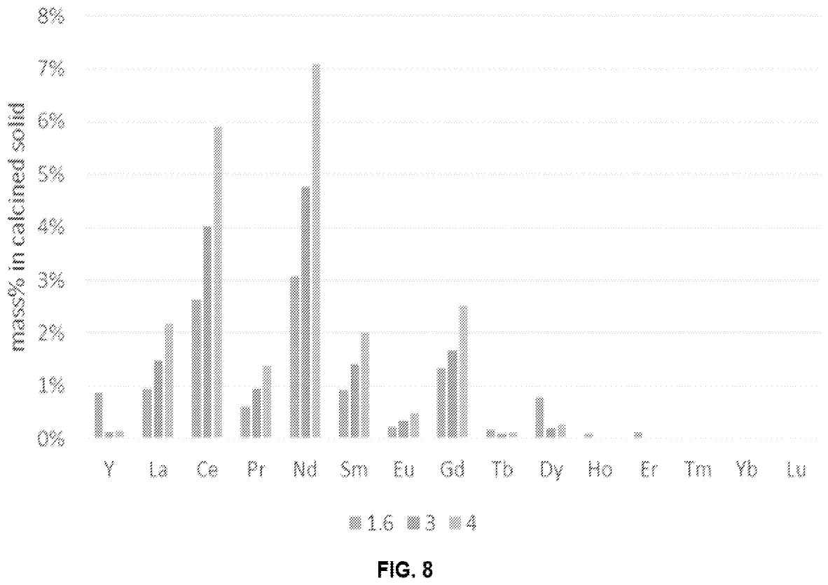

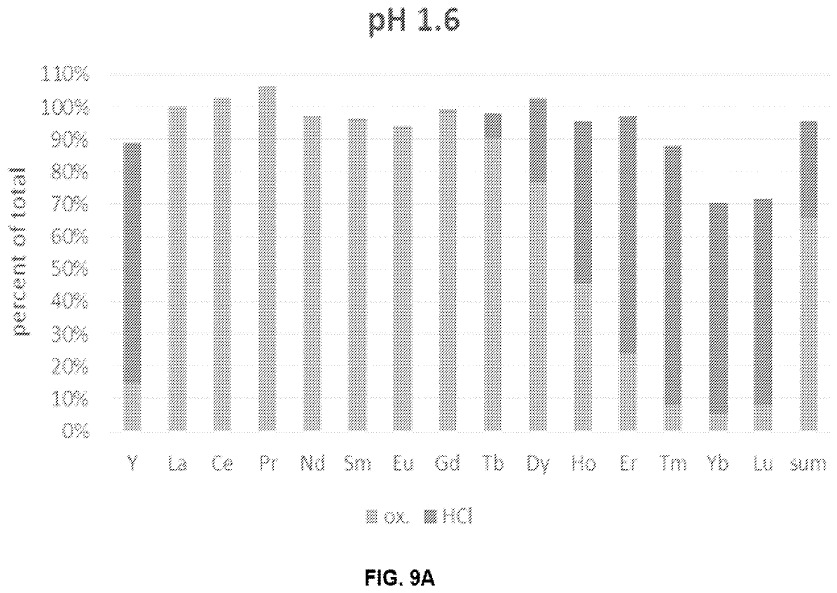

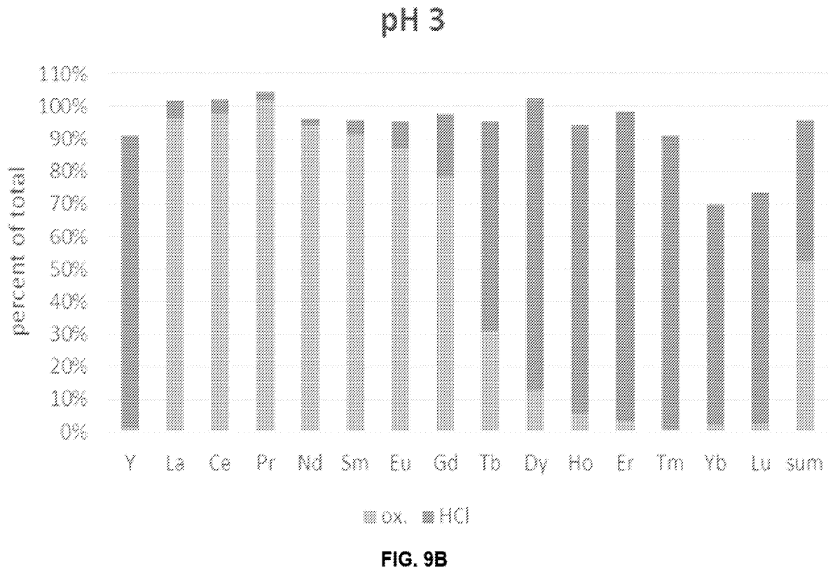

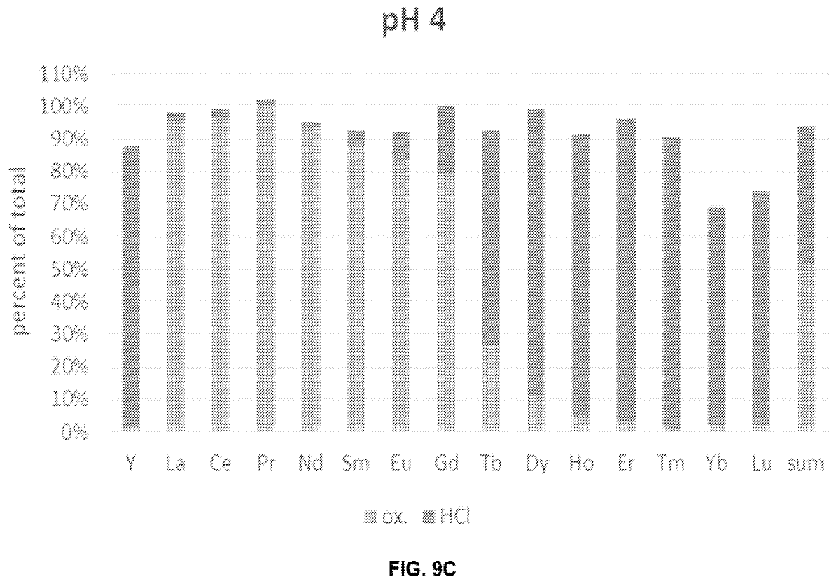

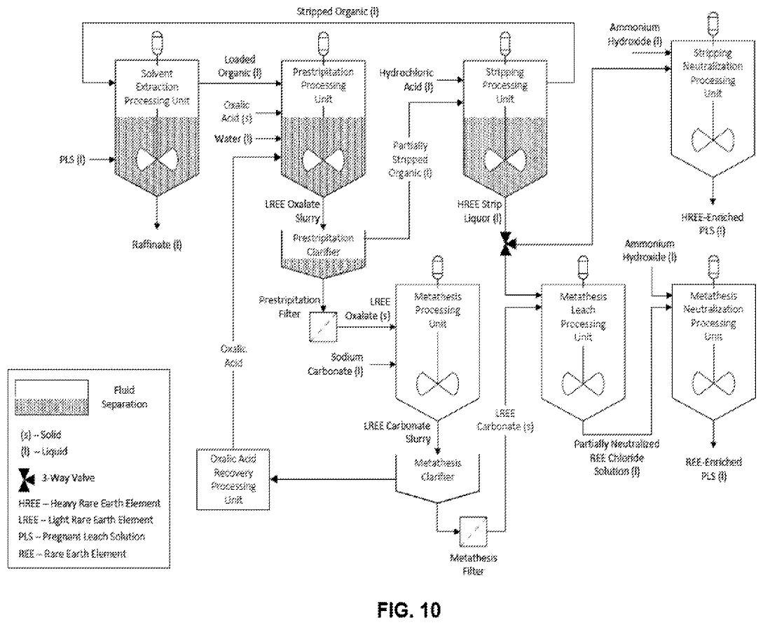

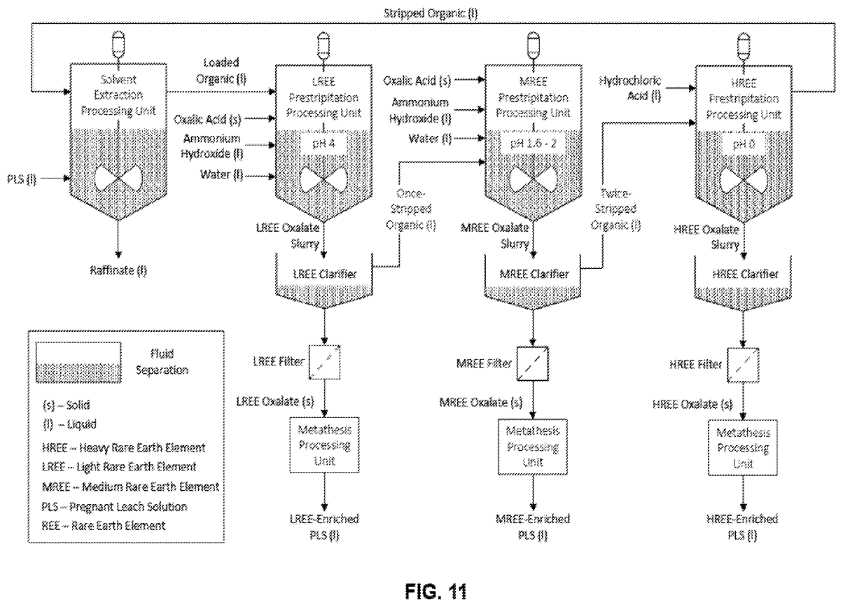

Disclosed Oxalic Acid-Based Extraction Method for Preparation of a Disclosed Pregnant Leach Solution-Post Organic Extraction (PLS-LOPSES) Product (Example Method 1B). The method is that described in FIG. 1A and describe above, except the pH of the oxalic acid extracting solution was adjusted with ammonia instead of sodium hydroxide and all other conditions/steps as described in the immediately foregoing example. Under these conditions, slightly higher masses of calcined solids (436 mg at pH 3 and 292 mg at pH 4). The composition of gangue metals and REEs in the calcined solids followed a similar pattern to the one observed above using sodium hydroxide for pH adjustment of the oxalic acid extracting solution (see FIG. 6). In particular, the mass % of REEs in the calcined solid increased and the mass % of gangue metals (mainly calcium and zinc) decreased markedly at pH 4. The percent of calcium and zinc extracted from the organic phase decreased with increasing pH (see FIGS. 7A-7B). At pH 4, zinc was not extracted, and calcium was the gangue metal present in the oxalate precipitates. The percent composition of each REE in the calcined solid (FIG. 8) exhibited a similar pattern (increasing percent with increasing pH) to the percent compositions discussed above (compared to FIG. 4). Similarly, the transition from preferred extraction into oxalic acid to preferred extraction into HCl shifted to the left (REES with lower atomic weight) with increasing pH (see FIGS. 9A-9C).

Exemplary Batch Solvent Extraction Systems and Methods. Referring now to FIG. 13A, an exemplary batch solvent extraction (BSX) unit can comprise a cylindrical mixer-settler tank (M-S tank) with an open top of suitable dimension, e.g., comprising 42-in diameter×10-ft tall steel cylindrical structure further comprising a 4-inch upper side port, and a 4-inch lower side port, but the BSX unit can be designed to any size to achieve the desired throughput. A BSX unit comprising 42-in diameter×10-ft tall steel cylindrical structure further comprising a 4-inch upper side port, and a 4-inch lower side port was designed to process 600 gallons per hour of a pregnant leach solution (PLS). Fresh or recycled organic phase (RO) can enter the SX tank from an external RO storage unit (RO storage) through a pipe into the top of the BSX. The lower side port can allow PLS to enter the M-S tank from a PLS storage unit (PLS storage). The lower side port can allow a processed raffinate (RAFF) to exit the M-S tank to a RAFF storage unit (RAFF storage). The upper side port is connected to the first end of a 90-degree pipe elbow (elbow) fixed within the M-S tank. A first square flange is welded to the second end of the elbow. This unit is vertically adjustable to allow fine tuning of the liquid's separation. Four rods oriented in the vertical direction can be welded to the first square flange to serve as a fixed track. An electric actuator lever-arm (actuator) mounted within the top of the M-S tank is attached to a second square flange and oriented in the horizontal direction such that the face of the first square flange (first face) and the face of the second square flange (second face) are parallel to and in alignment with each other. The actuator provides translation of the second face in the vertical direction along the fixed track to open or close the seal between the first face and the second face and act as a drain stopper to keep material from exiting the M-S tank through the upper side port. A first fluoroelastomer (FPM) gasket (first gasket) and a second FPM rubber gasket (second gasket) are connected to the first face and the second face, respectively, such that a tight seal is achieved when the first face and the second face are in firm contact.

The BSX unit, e.g., as shown in FIG. 13A, can be equipped with a mixer unit mounted to the top of the M-S tank oriented in the vertical direction driven by a Variable Frequency Drive (VFD) mixer motor. The motor can be configured to drive a geared reduction transmission that reduces the mixer shaft rotational RPM's. The mixer unit can utilize a mixer shaft that extends toward the base of the M-S tank with a mixer disk connected at the base of the mixer shaft. The mixer disk can optionally comprise six equally spaced curved fins connected to the underside of the mixer disk to promote mixing. The BSX can optionally further comprise 2-4 vertical longitudinal fins or baffles connected at equally spaced contact points within the M-S tank. Without wishing to be bound by a particular theory, it is believed that the baffles can enhance the RO and PLS mixing process.

The BSX unit, e.g., as shown in FIG. 13A, can further comprise a network of piping, valves, motors, meters, and pumps (network) connected to the top port, an upper side port, and the lower side port of the M-S tank. The network transports and controls the amount of and type of material entering and exiting the M-S tank at various port locations. For example, the upper side port can be connected to a RO shutoff valve in case the first or the second gasket fails while the BSX unit is in operation. A three-dimensional model of the BSX unit is shown in FIG. 13B; FIG. 13C shows an example BSX unit process flow schematic; and FIG. 13D shows an example BSX unit process flow schematic with expanded network connection to other processing units and systems.

To operate the BSX unit, an optimal organic phase (RO) to aqueous phase (PLS) volumetric ratio, or O:A ratio, can be determined based on the incoming PLS concentration. For example, an O:A ratio of about 0.05 was used for this example. Bench-scale laboratory testing determined that 1-6 cycles or contacts were typically needed to fully load the RO. The M-S tank described herein can process about 500 gal per contact. In an example of the contact sequence, the M-S tank is filled with 550 gal of PLS through the lower side port from the PLS storage. The M-S tank was filled with 27.5 gal of RO through the top from the RO storage. The VFD controlled mixer was turned on to mix the PLS and RO at a speed of 25 Hz for 15 min. The mixer was then turned off to allow the resultant solution to separate for about 20 min. After solution separation, 550 gal of the resulting RAFF was discharged from the lower side port to the RAFF storage while retaining the partially loaded organic in the M-S tank. The M-S tank was then refilled with another 550 gal of PLS from PLS storage. The same mixing and separation process or contact sequence was repeated until the sixth contact between the fresh PLS and partially LO is completed. This sixth contact resulted in a fully loaded LO. The separated LO was discharged from the upper side port to the LO storage.

The unit is designed to have 600 gallons of aqueous material mix in each contact. The bottom plate of the actuating drain is located for the volume below the drain plate to be 600 gallons. This the unit has ˜719 gallons of capacity. The designed unit could be operated with up to 50 gallons of organic. This would allow ˜10% head room (by volume) to achieve a max O:A ratio of 0.09. The unit could vary these volumes as the actuated drain (weir) could be moved up or down by adjusting the length of the vertical pipe attached to the weir. This would allow for an increased O:A ratio if moved down. If moved up the unit could process a greater throughput of PLS at a lower O:A ratio. In other design iterations the weirport could be moved to lower point on the unit to achieve higher O:A ratios such as a 1:1 ratio. This would be used for stripping or high concentration extractions.

The organic extractant used for REE extraction optimally contains 65% Elixir 205 (High Purity Kerosene), 25% Di (2-ethylhexl) phosphoric acid (DEHPA), and 10% Tri-Butyl Phosphate (TBP) by volume. Elixir 205 is seen as a diluent in this extractant and DEHPA is the primary rare earth extractant. Previous results indicate that Elixir 205 mixed with just TBP is not an effective extractant as seen in Table 8 below. Table 8 indicates a mixture of TBP and Elixir 205 is capable of extracting less than 5% of the total rare earth elements TREE.

The BSX unit was operated at a rare earth element (REE) pilot plant. In this example, PLS produced from acid mine drainage (AMD) containing REEs was extracted by the exemplary BSX unit described. The RO was contacted with fresh PLS (assay in Table 4 below) a total of six times (contacts). The average REE recovery was 90% with about 25% of the gangue elements extracted across all contacts. The test results can be found in Table 3 below. In the second iteration of the testing, a decreased O:A ratio was used as well as less contacts in an effort to extract fewer major metals. This test utilized PLS of the same analytical composition (Table 2) as Test 1. In this test, REE recovery averaged 88% and the major metal recovery averaged 17%. The full results for this test can be found in Table 5.

To evaluate if the organic is becoming loaded, the BSX loaded organic from Test 2 was assayed by stripping it twice with 6M HCl. It is important to note when analyzing this data that the extractant has a total metal loading capacity for 15 g/L. In this test, the organic was loaded with ˜2.3 g/L TREE and ˜9 g/L TMM for a total of ˜11.3 g/L metal loading. This analysis confirms that the organic was successfully loaded with both rare earths and major metals. Full detailed assays for the loaded organic can be found in Table 6 below.

Established solvent extraction technologies utilize a continuous flow types unit with a series of mixers and settlers. These units typically utilize low flow rates (<1 GPM) and require an internal recycle of the extractant to increase extraction efficiencies. They also require several days of stabilization to run efficiently. The test results shown below is on a stabilized unit. Test work was conducted using a series of 4 mixer settlers at an 0.053 O:A ratio. Results are in Table 5 blow shows the average recovery per day after 8 hours of continuous operation. The rare earth extraction averaged >99% over 1 week of operation while also extracting minimal Major Metals. While these results are better than the BSX, the through put of the BSX is 10 times higher. The BSX also has similar extraction performance and does not require a stabilization period.

TABLE 3
Recovery of TREE to Organic per BSX contact.

| | RAFF Out of | RAFF Out of | RAFF Out of | RAFF Out of |
|---|---|---|---|---|
| | BSX Contact 1 | BSX Contact 2 | BSX Contact 3 | BSX Contact 4 |
| | % Extracted | % Extracted | % Extracted | % Extracted |
| Element | from PLS | from PLS | from PLS | from PLS |
| Al | 29% | 23% | 22% | 21% |
| Ca | 33% | 6% | −7% | −15% |
| Co | −1% | −11% | −8% | −11% |
| Fe | 0% | 0% | 0% | 0% |
| Li | 0% | 0% | 0% | 0% |
| Mg | 0% | 0% | 0% | 0% |
| Mn | 1% | −11% | −8% | −8% |
| Na | 8% | 53% | 52% | 55% |
| Ni | −1% | −11% | −7% | −9% |
| Si | −2% | −10% | −11% | −15% |
| Zn | 32% | 40% | 53% | 54% |
| TMM | 10% | 26% | 26% | 27% |
| Sc | 93% | 93% | 81% | 73% |
| Y | 100% | 100% | 99% | 99% |
| La | 79% | 66% | 59% | 52% |
| Ce | 90% | 84% | 84% | 83% |
| Pr | 92% | 88% | 88% | 87% |
| Nd | 93% | 89% | 90% | 89% |
| Sm | 97% | 95% | 95% | 93% |
| Eu | 98% | 96% | 96% | 95% |
| Gd | 98% | 97% | 96% | 95% |
| Tb | 99% | 99% | 98% | 98% |
| Dy | 100% | 99% | 99% | 99% |
| Ho | 100% | 100% | 99% | 99% |
| Er | 100% | 100% | 99% | 99% |
| Tm | 100% | 100% | 99% | 99% |
| Yb | 99% | 99% | 99% | 98% |
| Lu | 99% | 99% | 98% | 98% |
| TREE | 95% | 92% | 92% | 91% |

| | RAFF Out of | RAFF Out of |
|---|---|---|
| | BSX Contact 5 | BSX Contact 6 |
| | % Extracted | % Extracted |
| Element | from PLS | from PLS |
| Al | 25% | 23% |
| Ca | −20% | −15% |
| Co | −11% | −7% |
| Fe | 0% | 0% |
| Li | 0% | 0% |
| Mg | 0% | 0% |
| Mn | −10% | −6% |
| Na | 57% | 52% |
| Ni | −9% | −5% |
| Si | −16% | −12% |
| Zn | 47% | 47% |
| TMM | 26% | 26% |
| Sc | 70% | 73% |
| Y | 99% | 99% |
| La | 41% | 40% |
| Ce | 73% | 72% |
| Pr | 78% | 77% |
| Nd | 80% | 79% |
| Sm | 88% | 88% |
| Eu | 91% | 91% |
| Gd | 93% | 93% |
| Tb | 97% | 97% |
| Dy | 98% | 98% |
| Ho | 99% | 99% |
| Er | 99% | 99% |
| Tm | 99% | 99% |
| Yb | 98% | 98% |
| Lu | 98% | 98% |
| TREE | 86% | 86% |

TABLE 4
PLS prior to BSX (ICP analysis)

| Element | Concentration | PLS prior to BSX |
|---|---|---|
| Al | mg/L | 131.3 |
| Ca | mg/L | 519.5 |
| Co | mg/L | 22.0 |
| Fe | mg/L | 0.0 |
| Li | mg/L | 0.0 |
| Mg | mg/L | 416.0 |
| Mn | mg/L | 361.7 |
| Na | mg/L | 1,856.2 |
| Ni | mg/L | 22.7 |
| Si | mg/L | 57.5 |
| Zn | mg/L | 79.2 |
| pH* | | 4.2 |
| TMM | mg/L | 3,466.1 |
| Sc | mg/L | 0.1 |
| Y | mg/L | 11.0 |
| La | mg/L | 2.5 |
| Ce | mg/L | 5.3 |
| Pr | mg/L | 1.1 |
| Nd | mg/L | 5.9 |
| Sm | mg/L | 1.8 |
| Eu | mg/L | 0.5 |
| Gd | mg/L | 3.0 |
| Tb | mg/L | 0.4 |
| Dy | mg/L | 2.3 |
| Ho | mg/L | 0.4 |
| Er | mg/L | 1.1 |
| Tm | mg/L | 0.1 |
| Yb | mg/L | 0.7 |
| Lu | mg/L | 0.1 |
| TREE | mg/L | 36.5 |

TABLE 5
Recovery of TREE to Organic per BSX (contact test 2)

| | RAFF Out of | RAFF Out of | RAFF Out of | RAFF Out of |
|---|---|---|---|---|
| | BSX Contact 1 | BSX Contact 2 | BSX Contact 3 | BSX Contact 4 |
| | % Extracted | % Extracted | % Extracted | % Extracted |
| Element | from PLS | from PLS | from PLS | from PLS |
| Al | 29% | 6% | 6% | 94% |
| Ca | 11% | −7% | −12% | −33% |
| Co | −7% | −11% | −8% | 99% |
| Fe | 0% | 0% | 0% | 0% |
| Li | 0% | 0% | 0% | 0% |
| Mg | 0% | 0% | 0% | 0% |
| Mn | −7% | −11% | −8% | 83% |
| Na | 2% | 0% | 0% | 96% |
| Ni | −7% | −10% | −7% | 100% |
| Si | −9% | −10% | −7% | 93% |
| Zn | 23% | 50% | 55% | 85% |
| TMM | 1% | −2% | −2% | 70% |
| Sc | 89% | 68% | 73% | 87% |
| Y | 100% | 99% | 99% | 99% |
| La | 46% | 44% | 42% | 31% |
| Ce | 73% | 79% | 80% | 73% |
| Pr | 79% | 86% | 86% | 80% |
| Nd | 83% | 89% | 88% | 83% |
| Sm | 95% | 95% | 92% | 93% |
| Eu | 96% | 95% | 93% | 94% |
| Gd | 97% | 95% | 93% | 95% |
| Tb | 98% | 98% | 97% | 97% |
| Dy | 99% | 99% | 98% | 98% |
| Ho | 99% | 99% | 99% | 98% |
| Er | 100% | 99% | 99% | 99% |
| Tm | 100% | 99% | 99% | 99% |
| Yb | 100% | 99% | 98% | 99% |
| Lu | 100% | 98% | 98% | 99% |
| TREE | 88% | 89% | 89% | 86% |

TABLE 6
Assay of Loaded Organic (Post BSX).

| | | | | Total Mass |
|---|---|---|---|---|
| | | Organic 6M | Organic 6M | Contained in 64.2 L |
| Element | Conc. | HCl strip 1 | HCl strip 2 | loaded organic (g) |
| Volume (L) | | 64.2 | 64.2 | |
| Al | mg/L | 2,644.3 | 124.5 | 177.6 |
| Ca | mg/L | 3,026.1 | 74.4 | 198.9 |
| Co | mg/L | 0.1 | 0.0 | 0.0 |
| Fe | mg/L | 0.8 | 0.3 | 0.1 |
| Li | mg/L | 0.0 | 0.0 | 0.0 |
| Mg | mg/L | 3.0 | 0.1 | 0.2 |
| Mn | mg/L | 144.6 | 3.4 | 9.5 |
| Na | mg/L | 3.1 | 1.1 | 0.3 |
| Ni | mg/L | 0.1 | 0.0 | 0.0 |
| Si | mg/L | 2.5 | 1.2 | 0.2 |
| Zn | mg/L | 2,666.4 | 367.3 | 194.6 |
| TMM | mg/L | 8,491.1 | 572.3 | 581.5 |
| Sc | mg/L | 0.0 | 0.0 | 0.0 |
| Y | mg/L | 705.8 | 57.5 | 49.0 |
| La | mg/L | 114.4 | 2.5 | 7.5 |
| Ce | mg/L | 366.3 | 8.4 | 24.0 |
| Pr | mg/L | 77.2 | 1.8 | 5.1 |
| Nd | mg/L | 389.1 | 8.9 | 25.5 |
| Sm | mg/L | 117.1 | 2.8 | 7.7 |
| Eu | mg/L | 30.2 | 0.8 | 2.0 |
| Gd | mg/L | 177.8 | 4.5 | 11.7 |
| Tb | mg/L | 25.5 | 0.8 | 1.7 |
| Dy | mg/L | 134.2 | 5.6 | 9.0 |
| Ho | mg/L | 24.6 | 1.4 | 1.7 |
| Er | mg/L | 59.1 | 6.1 | 4.2 |
| Tm | mg/L | 6.3 | 1.5 | 0.5 |
| Yb | mg/L | 21.4 | 10.6 | 2.1 |
| Lu | mg/L | 2.4 | 1.4 | 0.2 |
| TREE | mg/L | 2251.5 | 114.5 | 151.8 |

TABLE 7
Continuous Pilot Solvent % Recovery from PLS to extractant.

| | Day 1 | Day 2 | Day 3 | Day 4 | Day 5 |
|---|---|---|---|---|---|
| | Composite | Composite | Composite | Composite | Composite |
| | Percent | Percent | Percent | Percent | Percent |
| Element | Recovery | Recovery | Recovery | Recovery | Recovery |
| Al | 89% | −15% | 3% | 13% | 71% |
| Ca | 79% | 56% | 15% | 13% | 30% |
| Co | −4% | −10% | −5% | −7% | −13% |
| Fe | | | | | |
| Mg | −5% | −8% | −18% | −17% | −16% |
| Mn | 31% | 13% | −8% | −8% | −18% |
| Na | −9% | 0% | −25% | −23% | −36% |
| Ni | 3% | −6% | −13% | −13% | −8% |
| Si | 23% | 19% | 7% | −3% | 46% |
| Zn | 100% | 100% | 100% | 100% | 100% |
| TMM | 7% | 9% | −14% | −12% | −12% |
| Sc | 81% | 49% | 8% | 25% | 63% |
| Y | 99% | 99% | 98% | 99% | 99% |
| La | 100% | 100% | 100% | 100% | 100% |
| Ce | 100% | 100% | 100% | 100% | 100% |
| Pr | 100% | 100% | 100% | 100% | 100% |
| Nd | 100% | 100% | 100% | 100% | 100% |
| Sm | 100% | 100% | 100% | 100% | 100% |
| Eu | 100% | 100% | 100% | 100% | 100% |
| Gd | 100% | 100% | 100% | 100% | 100% |
| Tb | 100% | 100% | 99% | 99% | 100% |
| Dy | 100% | 100% | 99% | 99% | 100% |
| Ho | 100% | 99% | 99% | 99% | 99% |
| Er | 99% | 99% | 98% | 98% | 99% |
| Tm | 99% | 98% | 95% | 96% | 98% |
| Yb | 97% | 95% | 90% | 91% | 96% |
| Lu | 96% | 93% | 86% | 88% | 96% |
| TREE | 100% | 100% | 99% | 99% | 100% |

TABLE 8
65% Elixir 205, 35% TBP SX recovery from PLS, 0.06 O:A.

| | 65% E205, 35% | 65% E205, 35% | 65% E205, 35% | 65% E205, 35% |
|---|---|---|---|---|
| | TBP V/V, | TBP V/V, | TBP V/V, | TBP V/V, |
| Element | Contact 1 | Contact 2 | Contact 3 | Contact 4 |
| Al | 3% | 3% | 4% | 3% |
| Ca | 0% | −1% | 0% | 0% |
| Co | 0% | 0% | −1% | 0% |
| Fe | −27% | 100% | −1% | −14% |
| Mg | −1% | −1% | 0% | 0% |
| Mn | 0% | −1% | −1% | −1% |
| Na | −13% | −11% | −3% | −4% |
| Ni | −1% | −2% | 0% | 0% |
| Si | 3% | 2% | 3% | 2% |
| Zn | 0% | 0% | −2% | −1% |
| TMM | 0% | 0% | 0% | 0% |
| Sc | 91% | 75% | 99% | 93% |
| Y | 8% | 5% | 5% | 5% |
| La | −2% | −1% | −1% | −1% |
| Ce | 2% | 2% | 2% | 2% |
| Pr | 2% | 1% | 1% | 3% |
| Nd | 2% | 2% | 2% | 2% |
| Sm | −1% | −3% | −2% | −2% |
| Eu | 0% | 0% | 0% | 0% |
| Gd | 6% | 5% | 5% | 5% |
| Tb | 8% | 5% | 6% | 6% |
| Dy | 11% | 8% | 8% | 9% |
| Ho | 10% | 8% | 9% | 9% |
| Er | 11% | 8% | 9% | 8% |
| Tm | 14% | 11% | 12% | 10% |
| Yb | 23% | 18% | 20% | 15% |
| Lu | 23% | 18% | 22% | 13% |
| TREE | 5% | 4% | 4% | 4% |

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A method for preparation of a pregnant leach solution-post organic extraction, the method comprising:
providing a loaded organic phase from a solvent extraction system (LOPSES) comprising an organic solvent and at least one REE;
adding water and oxalic acid;
mixing the water and the oxalic acid with the LOPSES, thereby forming a mixture comprising a partially stripped organic solvent and a slurry comprising a REE-oxalate precipitate and water;
removing the partially stripped organic solvent from a slurry comprising the REE-oxalate precipitate and the water; and
filtering the slurry in a filtration apparatus, thereby forming a retentate and a filtrate;
wherein the organic solvent comprises at least one organic solvent;
wherein the REE-oxalate precipitate comprises at least one REE;
wherein the partially stripped organic solvent comprises at least one REE;
wherein the retentate comprises a light REE-oxalate precipitate; and
wherein the filtrate comprises water.

2. The method of claim 1, wherein the organic solvent comprises at least one hydrocarbon, at least one halohydrocarbon, or combinations thereof.

3.-4. (canceled)

5. The method of claim 1, wherein the LOPSES further comprises at least one ligand for a REE.

6. The method of claim 3, wherein the ligand comprises a dialkyl diglycol amic acid, a dialkyl phosphate, a trialkyl phosphate, a carboxylic acid, a phosphoric acid ester, a phosphonic acid, a phosphinic acid, or combinations thereof.

7. The method of claim 6, wherein the ligand comprises di-2-ethylhexylphosphoric acid (D2EHPA), 2-ethylhexyl phosphate, bis(2-ethylhexyl) phosphate (HDEHPA), 2-ethylhexylphosphoric acid-mono-2-ethylhexyl ester (HEH/EHP), bis(2,4,4-trimethylpentyl)phosphoric acid, dibutryl phosphate, tributyl phosphate (TBP), N,N-dioctyl-3-oxapentane-1,5-amic acid (DODGAA), N,N-bis(2-ethylhexyl)-3-oxapentane-1,5-amic acid (D2EHDGAA), or combinations thereof.

8. The method of claim 1, wherein the LOPSES is present in a LOPSES volume; and wherein adding water and oxalic acid to the LOPSES comprises adding a volume of water that is from about 0.5-fold to about 5.0-fold of the LOPSES volume.

9. The method of 8, wherein the adding water and oxalic acid to the LOPSES comprises adding an amount of oxalic acid that is from about 10 g/L oxalic acid to about 100 g/L oxalic acid based on a volume of water added to the LOPSES.

10. The method of claim 1, wherein the adding water and oxalic acid to the LOPSES comprises forming a solution of the water and the oxalic acid prior to adding to the LOPSES.

11.-13. (canceled)

14. The method of claim 1, wherein the base is a carbonate, an oxide, a hydroxide, or combinations thereof.

15.-17. (canceled)

18. The method of claim 1, wherein the REE-oxalate precipitate comprises at least one light REE-oxalate precipitate.

19. The method of claim 1, wherein the REE-oxalate precipitate comprises a mixture of at least one light REE-oxalate precipitate and at least one heavy REE-oxalate precipitate.

20.-21. (canceled)

22. The method of claim 1, further comprising adding a mineral acid to the partially stripped organic solvent, thereby forming a stripped organic phase and an aqueous strip liquor; and wherein the aqueous strip liquor comprises at least one heavy REE.

23.-30. (canceled)

31. The method of claim 1, further comprising removing the retentate to a metathesis reactor.

32. The method of claim 23, wherein sodium carbonate and water are mixed with the retentate, thereby forming a carbonate mixture comprising a light REE-carbonate precipitate and a wastewater; wherein the light REE-carbonate precipitate comprises at least one light REE; and wherein the wastewater comprises oxalate.

33.-38. (canceled)

39. The method of claim 1, wherein the pregnant leach solution-post organic extraction comprises at least one of lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration.

41.-47. (canceled)

48. A pregnant leach solution-post organic extraction prepared by the method of claim 1.

49. A method for preparation of a pregnant leach solution-post organic extraction, the method comprising:
providing a loaded organic phase from a solvent extraction system (LOPSES) comprising an organic solvent and at least one REE;
adding an aqueous oxalate solution;
mixing the aqueous oxalate solution with the LOPSES, thereby forming a mixture comprising a partially stripped organic solvent and a first slurry comprising a first REE-oxalate precipitate and water;
removing the partially stripped organic solvent from a first slurry;
adding water and oxalic acid to the removed partially stripped organic solvent thereby forming a twice-stripped organic solvent and a second slurry comprising a second REE-oxalate precipitate and water;
removing the twice-stripped organic solvent from the second slurry;
filtering the first slurry in a first filtration apparatus, thereby forming a first retentate and a first filtrate; and
filtering the second slurry in a second filtration apparatus, thereby forming a second retentate and a second filtrate;
wherein the organic solvent comprises at least one organic solvent;
wherein the first REE-oxalate precipitate comprises at least one REE;
wherein the second REE-oxalate precipitate comprises at least one REE;
wherein the partially stripped organic solvent comprises at least one REE;
wherein the first retentate comprises a light REE-oxalate precipitate;
wherein the second retentate comprises a heavy REE-oxalate precipitate;
wherein the first filtrate comprises water; and
wherein the second filtrate comprises water.

50. The method of claim 49, wherein the organic solvent comprises at least one hydrocarbon, at least one halohydrocarbon, or combinations thereof.

51.-52. (canceled)

53. The method of claim 49, wherein the LOPSES further comprises at least one ligand for a REE.

54.-100. (canceled)

101. A pregnant leach solution-post organic extraction prepared by the method of claim 49.
